(19) United States
(12) Patent Application Publication
(10) Pub. No.: US 2015/0133209 A1
(43) Pub. Date: May 14, 2015

(54) SOCIAL MEDIA-BASED VIRTUAL/ACTUAL INTERACTIVE GAMES

(71) Applicant: CodeGeo, LLC, Salem, OR (US)

(72) Inventors: Paul D. Patterson, Vancouver, WA (US); Michael G. Powell, Stayton, OR (US); Bradley R. Bowder, Salem, OR (US)

(21) Appl. No.: 14/538,369

(22) Filed: Nov. 11, 2014

Related U.S. Application Data
(63) Continuation-in-part of application No. 14/213,226, filed on Mar. 14, 2014.
(60) Provisional application No. 61/902,722, filed on Nov. 11, 2013.

(51) Int. Cl. A63F 13/58; A63F 13/792; A63F 13/69

(52) U.S. Cl. CPC A63F 13/58; A63F 13/69; A63F 13/792
USPC 463/25; 463/31

(57) ABSTRACT

An example embodiment includes a method of awarding an actual benefit in a geocaching environment. The method includes identifying a proposed action to be performed by the player during interaction of a player in a virtual environment of a game or a social media game. The method includes identifying the player. The method includes determining a virtual benefit and an actual benefit provided to the player for completion of the proposed action based on the identified proposed action and player information associated with the player. The method includes presenting the proposed action to the player. The method includes receiving an acceptance of the proposed action. The method includes receiving a confirmation that the player performed the proposed action. In response to the confirmation, the method includes awarding the virtual benefit and the actual benefit to the player.

### CROSS REFERENCE TO RELATED PATENT APPLICATIONS

This patent application claims priority to and the benefit of U.S. Provisional Applications No: 61/902,722, which is incorporated herein by reference in its entirety. This application is also a continuation-in-part of U.S. patent application Ser. No. 14/213,226, which is incorporated herein by reference in its entirety.

### FIELD

The embodiments discussed herein are generally related to social media-based virtual/actual interactive games.

### BACKGROUND

Geocaching is an outdoor recreational activity in which participants, called players, use a global positioning system (GPS) receiver, a mobile device, and other navigational techniques to hide-and-seek containers referred to as “geocaches.” Geocaching is similar to benchmarking, trigpointing, orienteering, treasure-hunting, letterboxing, and waymarking. The geocaches may be hidden anywhere in the world. An example geocache may be a small waterproof container in which a logbook is placed. When the geocache is found, the player who finds the geocache writes the date she found the cache in the logbook and signs the logbook. The signature of the player may include a real name or a code name the player previously established. Larger geocaches such as plastic storage containers or ammunition boxes may contain items which are referred to as geoseeds. The geoseeds can include toys or trinkets.

The geoseeds are traded among players. Additionally, some geoseeds are referred to as trackables. The trackable may have a serial number or another distinct marking. The trackables are transported from one geocache to another by the players. Geocache websites log the travel and interaction history of the trackables. Players may view the travel and the interaction history of the trackables by interacting with the geocache websites. Geocaches are currently placed in over two hundred countries, all seven continents, and on the International Space Station. After nearly thirteen years of activity, there are over 1.9 million active geocaches published on multiple geocache websites.

The subject matter claimed herein is not limited to embodiments that solve any disadvantages or that operate only in environments such as those described above. Rather, this background is only provided to illustrate one example technology area where some embodiments described herein may be practiced.

### SUMMARY

An example embodiment includes a method of awarding an actual benefit in a geocaching environment. The method includes identifying a proposed action to be performed by the player during interaction of a player in a virtual environment of a game or a social media game. The method includes identifying the player. The method includes determining a virtual benefit and an actual benefit provided to the player for completion of the proposed action based on the identified proposed action and player information associated with the player. The method includes presenting the proposed action to the player. The method includes receiving an acceptance of the proposed action. The method includes receiving a confirmation that the player performed the proposed action. In response to the confirmation, the method includes awarding the virtual benefit and the actual benefit to the player.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example geocaching/treasure hunting environment (geocaching environment) in which some embodiments may be implemented;

FIG. 2A is a block diagram of a computing device that may be included in the geocaching environment of FIG. 1;

FIG. 2B is another block diagram of the computing device of FIG. 2A;

FIG. 3 illustrates an example set of clues that may be used in the geocaching environment of FIG. 1;

FIG. 4 illustrates an example map that may be provided in the geocaching environment of FIG. 1;

FIG. 5 illustrates an example geocache that may be implemented in the geocaching environment of FIG. 1; and

FIGS. 6A-6D are a flow diagram of an example method of awarding an actual benefit in a geocaching environment,

FIG. 7 is a flow diagram of another example method of awarding an actual benefit in a geocaching environment,

FIG. 8 is a flow diagram of another example method of awarding an actual benefit in a geocaching environment,

all arranged in accordance with at least one embodiment described herein.

### DESCRIPTION OF EMBODIMENTS

Some embodiments discussed herein are generally related to social media-based virtual/actual interactive games. The social media-based virtual/actual interactive games may be implemented in a geocaching/treasure hunting environment (geocaching environment). The geocaching environment allows advertisers to sponsor geoseeds and/or areas surrounded by a digital fence and to provide an actual benefit such as a gift card for locating the sponsored geoseed or for entering the sponsored area. Players may interface with a geocache/treasure hunting server (geocache server) that communicates coordinates of the geoseeds or the digital fence to the players. The geocache server may supply the coordinates to the players during their interaction with a game that may be at least partially computer-based and/or during their interaction with a social media game. The geocache server hosts the game and a social media server hosts the social media game. In the game and the social media game, multiple players can compete or collaboratively play. The games and the social media games involve virtual game actions and actual game actions. The actual game actions include the players locating the geoseeds or physically entering the areas surrounded by the digital fences. The virtual game actions may include the players achieving a virtual goal in a virtual environment of the games and the social media games. In some embodiments, the geocache server may interface with a social media server such that portions of the social media game and of the game combine. Accordingly, data generated in the social media game may be reflected in the game and vice versa. Additionally, the players may have a single set of player information that is updated by virtual actions in the social media game and the game and by actual actions. Some additional embodiments are explained with reference to the accompanying drawings.

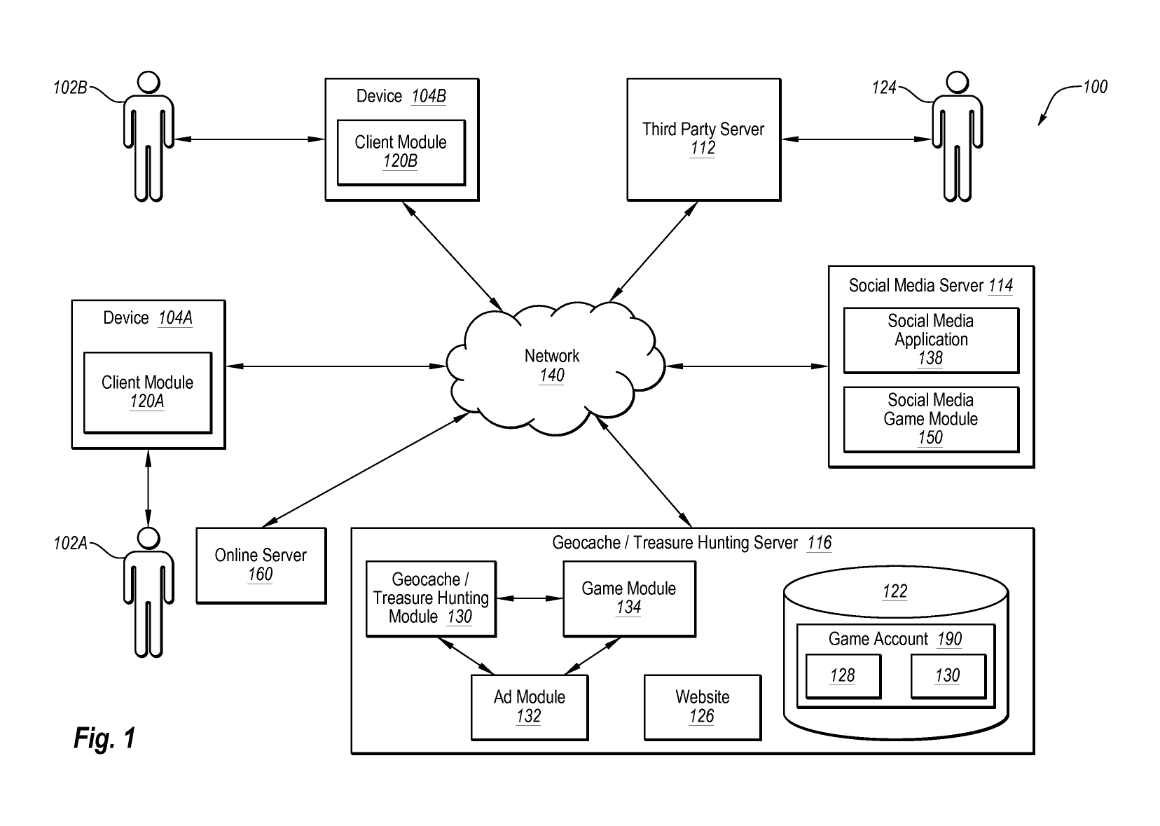

FIG. 1 illustrates a block diagram of an example geocaching environment 100 in which some embodiments may be implemented. The geocaching environment 100 may be configured to support geocaching activities and/or global positioning system (GPS) searching activities (e.g., activities involving digital fences). The geocaching environment 100 in some embodiments enables players 102A and 102B (generally, player 102 or players 102) to participate in a game hosted at least partially by a geocache server 116 and a social media game hosted by a social media server 114. Additionally, the geocaching environment 100 may enable an advertiser 124 to distribute advertisements in geocaches and geoseeds that are hidden and found by the players 102 and/or in areas surrounded by digital fences that are located by players 102. Furthermore, the geocaching environment 100 may enable the advertiser 124 to provide an actual benefit to the players 102 for locating the geocache, the geoseed, for physically entering an area surrounded by a digital fence, obtaining virtual benefit in a virtual environment of the game and/or the social media game, or any combination thereof

For example, the advertiser 124 may sponsor a geoseed, which may be hidden in a particular geocache. The advertiser 124 may place an advertisement and/or an actual benefit in the geocache in which the sponsored geoseed is placed. The player 102 may then interface with the geocache server 116 or the social media server 114 to receive coordinates of the particular geocache. When the player 102 locates the sponsored geoseed, the player 102 may communicate verification information to the geocache server 116 evidencing the location of the geoseed. In response, the player 102 may be awarded the actual benefit. In addition to the award of the actual benefit, the player 102 may be advanced in the game or the social media game.

As another example, the advertiser 124 may sponsor an area surrounded by a digital fence. The advertiser 124 may place an advertisement and/or an actual benefit in the area. The player 102 may then interface with the geocache server 116 or the social media server 114 to receive coordinates of the digital fence. When the player 102 physically enters the area, the player 102 may communicate verification information and/or positional data to the geocache server 116 evidencing that the player 102 has physically entered the area. In response, the player 102 may be awarded the actual benefit. In addition to the award of the actual benefit, the player 102 may be advanced in the game or the social media game.

The game and the social media game are not limited to actual actions that involve humans players 102 looking for geocaches. For example, some embodiments involve pets of the players 102. Instead of the geocache or the digital fence that is intended for a person (e.g., the player 102) to find or enter, a “pet seed” may be placed that is meant to attract an animal. As another example, the advertiser 124 may include pet-related sponsor such as a veterinarian, a pet store, a pet food producer, or similar entity. The pet-related sponsor may sponsor a pet seed, which may be placed in an area surrounded by a digital fence or having GPS coordinates associated therewith. The player 102 may download the coordinates and take her pet to find the pet seed. The pet seed may include an advertisement for the pet-related sponsor, may include an actual benefit, and may provide a virtual benefit in a game or a social media game that may be played by the player 102 and her pet. Some example pet seeds may include bones or pet toys that may or have applied thereto a specific scent (e.g., bacon).

In general, the game and/or the social media game may involve locating geocaches and/or physically entering into an area surrounded by digital fences as well as performing virtual actions in a virtual environment provided in the game or the social media game. The sponsored geoseed, another geoseed, or an area surrounded by a digital fence may also have a virtual benefit associated with it. The virtual benefit may be used as points in the game or the social media game, for instance. Play of the game or the social media game by the players 102 may include locating geocaches to recover the virtual benefits and the actual benefits, physically entering multiple areas surrounded by digital fences to recover the virtual benefits and the actual benefits, along with other sub-games which may have associated therewith additional virtual benefits in a competitive setting or a collaborative setting.

The geocaching environment 100 depicted in FIG. 1 includes devices 104A and 104B (generally, device 104 or devices 104) associated with the players 102 (and their pets). The geocaching environment 100 also includes a third party server 112, the social media server 114, and the geocache server 116. The devices 104, the third party server 112, the social media server 114, and the geocache server 116 are communicatively coupled via a network 140. In the geocaching environment 100, the geocache server 116 includes a geocache/treasure hunting module (geocache module) 130, a game module 134, a social media game module 150, and an ad module 132. Additionally, the devices 104 include client modules 120A and 120B (generally, client module 120 or client modules 120). The client modules 120, the geocache module 130, the game module 134, the social media game module 150, and the ad module 132 are configured to communicate information and data via the network 140 that may be used in geocaching by the players 102, locating digital fences by the players 102, playing the game or the social media game, playing the social media game, sponsoring geoseeds, determining and awarding virtual and actual benefits, as well as one or more other operations as described herein.

The network 140 may be wired or wireless, and may have numerous different configurations including a star configuration, token ring configuration, or other configurations. The network 140 may include a local area network (LAN), a wide area network (WAN) (e.g., the Internet), a metropolitan area network (MAN), a portion of the Internet, a portion of the Public Switched Telephone Network (PSTN), and/or other interconnected data paths across which multiple devices may communicate. In some implementations, the network 140 may be a peer-to-peer network. The network 140 may also be coupled to or include portions of a telecommunications network for sending data in a variety of different communication protocols. In some implementations, the network 140 includes BLUETOOTH® communication networks or a cellular communications network for sending and receiving data including via short messaging service (SMS), multimedia messaging service (MMS), hypertext transfer protocol (HTTP), direct data connection, wireless application protocol (WAP), email, etc.

The third party server 112 may include a hardware server that includes a processor, memory, and network communication capabilities. In the illustrated implementation, the third party server 112 is coupled to the network 140. The third party server 112 may send and receive data to and from one or more of the devices 104, the geocache server 116, and the social media server 114 via the network 140. The third party server 112 may be associated with the advertiser 124. For example, the advertiser 124 may own, operate, or regularly access the geocaching environment 100 via the third party server 112. The advertiser 124 may include any entity including an individual, a corporate entity, or government entity.

The advertiser 124 may communicate with the ad module 132 of the geocache server 116 via the network 140 and the third party server 112. For example, the ad module 132 may host or facilitate an automated or semi-automated auction for advertising opportunities. The advertising opportunities may include incorporating an advertisement in a geoseed or an area surrounded by a specific digital fence, assigning a digital fence within a proximity of an establishment of the advertiser 124, and sponsoring a specific player 102, being associated with a specific virtual action in the game and/or the social media game, being associated with a specific actual action in the game and/or the social media game, placing sponsored geocaches at locations, placing advertisements at an area surrounded by a specific digital fence, placing actual benefits in geocaches, and placing actual benefits in areas surrounded by a specific digital fence.

The advertiser 124 may communicate a bid offered for one or more of the advertising opportunities to the geocache server 116. For instance, the advertiser 124 may communicate a bid for sponsorship of a geoseed or area surrounded by a specific digital fence used in a specific social media game, which may be triggered by a specific virtual action being taken in the social media game. An acceptance or a rejection of the bid may be communicated from the geocache server 116 to the third party server 112 via the network 140. The advertiser 124 may receive the acceptance at the third party server 112.

Additionally, the advertiser 124 may access information such as game information 142 and/or player information 128 stored on memory 122. The memory 122 may include game information 142 and player information 128 for one or more of the players 102 as a game account 190 associated with the player 102. The player information 128 may include information pertaining to the players 102 such as the demographic information, actual benefit preferences and categories, interests, and preferred gaming characteristics. The game information 142 may include a current status of one or more players 102 in one or more games or social media games, current characters in such games, player attributes, in-game assets, relationships between players 102, and the like. From this information, the advertiser 124 may better relate the actual benefit to the players 102, which may be used as a basis for bids. For example, in some embodiments, there may be hundreds or thousands of actual awards available to the players 102. The player information 128 may include a category (e.g., clothes, electronics, or outdoor gear) of actual awards that the player 102 is interested in receiving. The advertisers 124 may accordingly use the selected category as a basis upon which the advertiser 124 bids.

Additionally, the advertisers 124 may use the player information 128 and/or the game information 142 to determine which actual benefits and/or virtual benefits to sponsor for which players 102.

In some embodiments in which the advertiser 124 bids on an advertising opportunity, after a bid is accepted, the sponsorship of the advertiser 124 may be associated with a geoseed and/or a digital fence. The advertiser 124 may then communicate the actual benefit provided for locating the geoseed. Additionally, the geocache server 116 may communicate coordinates of the sponsored geoseed or the sponsored digital fence to the advertiser 124 via the third party server 112. The advertiser 124 may then physically place the actual benefit and/or a particular geoseed in a geocache containing the sponsored geoseed or in the sponsored digital fence.

Additionally or alternatively, the advertiser 124 may physically place an advertisement in the sponsored geoseed or in the sponsored digital fence. For example, the advertiser 124 may sponsor multiple pet seeds that include actual benefits along one trail. The advertiser 124 may then place an advertisement at a trailhead or another location that the players 102 may see.

The third party server 112 may also be used to communicate information and data related to the actual benefit. For example, the advertiser 124 may provide an actual benefit such as a coupon or a gift card to the geocache server 116 via the network 140. Additionally, the third party server 112 may be used to communicate advertisements to be used in sponsored geoseeds or sponsored digital fences, instructions for redemption of the actual benefits, and details of digital fences to the geocache server 116 via the network 140.

In some embodiments, the players 102 may access or view information communicated between the third party server 112 and the geocache server 116. Specifically, the players 102 may use the devices 104 to view the information. For example, the players 102 may view the information related to the actual benefits or virtual benefits via the network 140.

The player 102 may be allowed to select the advertiser 124 as a sponsor from a set of advertisers. The player 102 may then be associated with the advertiser 124 to cooperatively promote products or services of the advertiser 124.

The third party server 112 may interface with the social media server 114. For example, the third party server 112 may monitor progress of players in social media games and place incentives, advertisements, actual benefits, or virtual benefits in the information feed (e.g., TIMELINE on TWITTER® or the News Feed on FACEBOOK®) of the players 102. Additionally or alternatively, the third party server 112 may communicate incentives, advertisements, actual benefits, or virtual benefits directly to an account of the player 102 via the social media server 114.

The social media server 114 may include a hardware server that includes a processor, memory, and network communication capabilities. In the illustrated implementation, the social media server 114 is configured to communicate via the network 140. The social media server 114 may send and receive data to and from one or more of the devices 104, the geocache server 116, and the third party server 112 via the network 140.

The social media server 114 includes a social media application 138 that supports a social network. The social network includes a social structure in which the players 102 and/or multiple other users may be connected by a common feature. The common feature includes relationships or connections such as friendship, family, work, an interest (e.g., geocaching), and the like. The common features may be provided by the social media application 138. For example, the social media application may provide explicitly defined relationships and relationships implied by social connections between online users. The relationships and/or the common features may form a social graph in the social network.

In some examples, the social graph can reflect a mapping of the players 102 and the other users and how they can be related. Furthermore, the social media server 114 and the social media application 138 may be representative of one social network and that there may be multiple social networks coupled to the network 140, each having its own server, application, and social graph. For example, a first social network may be more directed to business networking, a second may be more directed to or centered on academics, a third may be more directed to local business, a fourth may be directed to dating and others may be of general interest or a specific focus.

In some embodiments, the social media application 138 may be configured to provide a user interface to one or more of the players 102 operating one of the devices 104. The user interface provides to the players 102 an interface through which the players 102 may interact with the geocache server 116, a module (e.g., 130, 132, and 134) included therein, the devices 104 of other players 102 and/or the third party server 112.

The social network includes a service that provides an information feed describing one or more social activities specific to one of the players 102 or to another entity. For example, the information feed provided by the social network may allow the players 102 or another entity to describe actions that may be relevant to a game, events involving the players 102, expressed thoughts or opinions, and the like.

The social media server 114 may also include a social media game module 150. The social media game module 150 may be configured to host or support the social media game. The social media game may include a virtual gaming environment for one or more of the players 102 interfacing with the social network. The social media gaming environment may enable players 102 to collectively and cooperatively play a social media game. Additionally, the social media gaming environment may enable players 102 to view progress of other players in the social media game. In some embodiments, each of the players 102 may independently take actions in the social media game, which may be followed by an action by another of the players 102 interfacing with the social network. In some embodiments, the players 102 may concurrently play the social media game.

The social media game hosted or supported by the social media game module 150 may include multiple game actions. The game actions (e.g., virtual and actual) of the social media games include any step or play performed by the players 102 in furtherance of the game. The social media games may include one or more virtual game actions and one or more actual game actions. The virtual game actions may be performed through communication of digital data via the network 140. The actual actions may be performed in a real-world environment. In the social media game, other players 102 interacting with the social network may informed and updated in essentially real time as to the game actions of the players 102.

In some embodiments, the game module 134 may combine with the social media game module 150 to provide a game interface to the players 102. For example, the social media game module 150 may be configured to host a first portion and the game module 134 may be configured to host a second portion. The game module 134 and the social media game module 150 may both interface with the players 102.

For example, the player 102 may interface with the social media game and a game hosted by the game module 134 independently. An actual action (e.g., location of a geoseed) may be prompted in both of the social media game and the game hosted by the game module 134. When the player 102 locates the geoseed, this accomplishment may be reflected in both the social media game and the game hosted by the game module 134.

Additionally, game actions in the game hosted by the game module 134 may be taken via the social media application 138 and/or the game module 134. Additionally, results of the game actions and the player information 128 accessible via the game module 134 may be reflected in the social network. For example, a social media profile may be updated to include the player information 128. The player information 128 may be posted in an information feed of the player 102, and the player information 128 may be entered into a social media game module 150.

In another example, the player 102 can locate a geoseed or physically enter an area surrounded by a digital fence. For locating the geoseed or entering the area, the player 102 can be awarded an actual benefit and a virtual benefit associated with the geoseed or the area. When location of the geoseed or entry into an area surrounded by a specific digital fence is authenticated, the addition of the virtual benefit may be reflected in the social network, the social media game module 150, and in the game module 134. If the addition of the virtual benefit unlocks or increases status in the game or the social media game, then the player 102 can take a subsequent game action using the game module 134, the social media application 138, or the social media game module 150.

Additionally or alternatively, the geocache module 130 and/or the ad module 132 may interface with the social media application 138 to provide one or more operations attributed to the geocache module 130 or the ad module 132 via the social network. Moreover, the social media application 138 may be configured in some embodiments to perform one or more of the operations attributed to the geocache module 130 and/or the ad module 132. For example, the players 102 may access maps or player feedback via the social network. Additionally, the players 102 may view actual benefits or interface with the advertiser 124 via the social network.

The devices 104 may include a computing device that includes a processor, memory, and network communication capabilities. Generally, the devices 104 enable interaction between the players 102 and the other components of the geocaching environment 100. The players 102 may include individuals, groups of individuals, individuals with their pets, who may search for geoseeds, digital fences, and/or actual benefits and virtual benefits associated therewith. The players 102 may determine locations of geocaches and/or digital fences by accessing the geocache server 116 or the social media server 114 via the network 140 and the device 104. The players 102 may then locate the geocache or physically enter the area surrounded by the digital fences. When the players 102 locate the geocache, the player 102 may log the find within the geocache server 116, the social network, and/or in a website 126 utilizing the device 104. Additionally, the players 102 may place the geoseed into a second geocache or another type of hidden container. The players 102 may then hide the second geocache. The players 102 may log the new location of the second geocache with the geocache server 116, the social network, and/or in a website 126. The player 102 may also log their finds, experiences, photos, and obtain new geocache and/or geoseed coordinates through interfacing with the geocache server 116 or in the social network.

One or both of the devices 104 may include a laptop computer, a desktop computer, a tablet computer, a mobile telephone, a smart phone, a personal digital assistant (PDA), a mobile email device, a portable game device, a portable music device, a television with one or more processors embedded therein or coupled thereto, or other electronic device capable of accessing the network 140. The device 104 may access the social media server 114, the geocache server 116, the third party server 112, or any combination thereof via the network 140.

The devices 104 may include the client modules 120. The client modules 120 may be configured to enable interaction between the players 102 (e.g., between a first player 102A and a second player 102B), between the players 102 and the geocache server 116, between the players 102 and the social media server 114, or any combination thereof. The client modules 120 may be configured to provide a user interface to the player 102 that may allow the player 102 to interact with one or more of the geocache module 130, the ad module 132, the game module 134, and the social media application 138.

For example, the client modules 120 may provide access to maps of geocaches and/or digital fences, lists of geocaches and/or digital fences, player feedback, and other geocache-related information that may be stored and/or controlled by the geocache module 130. Additionally, the client module 120 may enable the player 102 to communicate a player inquiry to the geocache module 130. In response to the player inquiry, the geocache module 130 may provide coordinates of a geocache or a digital fence to the client module 120. In some embodiments, the player inquiry may be communicated via the social media server 114. For instance, during interface with the social network, the player 102 may communicate player inquiry to the geocache module 130. In these and other embodiments, the coordinates of the geocache or the digital fence may be posted to the information feed of the player or messaged to the player via the social network.

The coordinates may be provided as digital data, which may be loaded automatically or semi-automatically to the client module 120. As the player 102 attempts to locate the geocache or the digital fence, the client module 120 may track a current location with reference to the coordinates communicated to the device 104 by the geocache module 130. In some embodiments, the current location may be determined from global positioning system (GPS) signals, for instance. In some embodiments, after the player 102 locates the geocache and/or physically enters an area surrounded by the digital fence, the client module 120 may communicate verification information to the geocache server 116 via the network 140.

The client modules 120 may also enable observation of activities between the players 102. For example, the first player 102A may be able to observe progress the second player 102B is making towards locating a geocache. In this example, the first player 102A may receive updates on a first device 104A in the form of text messages, email messages, pushed digital messages, links or posts to an information feed in the social network, or any other suitable digital messaging.

Additionally, the client module 120 may allow the player 102 to interact with the ad module 132. For example, the player 102 may view sponsored geocaches, view actual benefits associated with geoseeds or digital fences, redeem an actual benefit, gain access to the actual benefit, and access descriptions of the actual benefits. In some embodiments, the players 102 may interact with the ad module 132 to select an advertiser (e.g., 124) as a sponsor.

Additionally, the client module 120 may allow the player 102 to interact with the game module 134 and the social media game module 150. For example, the player 102 may enter into a game (e.g., choose to participate in the game) or a social media game, select a particular style of game or a social media game, and take a game action in an ongoing game or a social media game using the client module 120. For example, a user interface provided by the client module 120 may include a game user interface that displays a list of games and/or social media games the player 102 may join, current or past standings of the players 102 participating in a game or a social media game, and the like.

Additionally, the client module 120 may allow or provide personalized access to the geocache server 116. In some embodiments, one or more of the geocache module 130, the ad module 132, and the game module 134 may be accessed using a player login. The player login may link the player 102 to a personalized account. For example, the player 102 may provide the player information 128 including age, gender, geocache experience, associate players, and the like.

Additionally, through participation in games and/or locating geocaches or digital fences, the player information 128 and/or the game information 142 may be updated. For instance, when the player 102 locates a particular geocache, the player information 128 and/or the game information 142 may include an indication reflecting the located geocache, a virtual benefit received, an actual benefit received, an updated standing in a game, a character used by the player 102, in-game assets, and the like. The player information 128 may be stored in the memory 122.

Additionally, the client module 120 may at least partially enable the player 102 to interface with the social media application 138. The information in the personalized account of a player may be coordinated with an account in a social network. For example, information included in a social media account may be shared with a login account of the geocache module 130. Additionally or alternatively, the game module 134 may communicate information to the player 102 by posting the information in the information feed supported in the social media application 138.

One or more of the functions described herein that are attributed to the client module 120 may be performed by a mobile application or a thin-client application. Additionally, in some embodiments, one or more of the devices 104 may perform one or more of the operations described herein by interfacing with a browser. In these and other embodiments, the geocache module 130, the game module 134, the ad module 132, the social media application 138, the geocache server 116, or some combination thereof may provide and support a user interface to the players 102 on the devices 104 via the browser.

The geocache server 116 may include a hardware server that includes a processor, memory, and network communication capabilities. In the illustrated implementation, the geocache server 116 is coupled to the network 140. The geocache server 116 may send and receive data to and from one or more of the devices 104, the social media server 114, and the third party server 112 via the network 140. The geocache server 116 may include the geocache module 130, the game module 134, and the ad module 132.

The geocache module 130, the game module 134, and the ad module 132 may be configured to provide the players 102 with actual benefits for locating geocaches and/or physically entering digital fences. Additionally, the geocache module 130, the game module 134, and the ad module 132 may be configured to enable sponsorship by the advertiser 124 of geoseeds found in geocaches and/or digital fences.

In some embodiments the geocache module 130 may be configured to receive a player inquiry. The player inquiry may be communicated from one of the devices 104 via the network 140 or via a social network hosted by the social media server 114. The player inquiry may identify a specific geocache or geoseed that the player 102 wants to locate.

Additionally or alternatively, the player inquiry may identify a specific digital fence the player 102 wants to enter and/or the player inquiry may identify a specific actual benefit or a specific virtual benefit the player 102 wants to be awarded. In response to the player inquiry, the geocache module 130 may provide coordinates of one or more corresponding geocaches and/or digital fences. For example, if a player inquiry identifies a specific actual benefit, the geocache module 130 may communicate the coordinates of one or more geocaches that have associated therewith the specific actual benefit. The one or more geocaches may include geocaches in which a geoseed sponsored by the advertiser 124 is placed.

The coordinates may be communicated to the device 104 via the network 140 and/or posted to the social network. The coordinates may be loaded to the device 104 and/or to the client module 120. In circumstances in which coordinates of multiple geocaches are communicated, the player 102 may select one of the coordinates. The coordinates may then be loaded to the client module 120.

The geocache module 130 may identify an actual benefit provided for locating the geoseed and or entering an area surrounded by the digital fence. The actual benefit may be associated with the advertiser 124. The actual benefit may include any good or service. For example, the advertiser 124 may include a hiking boot company and the actual benefit may include a certificate for a pair of boots.

In some embodiments the geocache module 130 may identify the actual benefit before the player 102 locates the geocache or enters the area surrounded by the digital fence. For example, when the geocache module 130 communicates the coordinates, the geocache module 130 may also identify the actual benefit. Additionally or alternatively, the geocache module 130 may identify the actual benefit in a communication after the communication of the coordinates, the geocache module 130 may identify the actual benefit prior to receiving the player inquiry, and the geocache module 130 may identify the actual benefit after the player 102 locates the geocache or the digital fence. For example, the player 102 may locate the geocache using the coordinates loaded onto the device 104. The geocache module 130 may identify the actual benefit to the player 102 when the player 102 logs the location of the geocache.

The geocache module 130 may also be configured to receive the confirmation signal. The confirmation signal may indicate that the player 102 has located a geocache or has entered an area surrounded by the digital fence. The confirmation signal may verify that the player 102 has actually located the geoseed or actually entered the area surrounded by a digital fence. The confirmation signal may include verification information that may be specific to a geoseed or may include a signal indicating a current location of the player 102 from which the geocache server 116 may determine whether the player has physically entered the area surrounded by the digital fence.

In some embodiments, the player inquiry, the identity of the actual benefit, the confirmation, or some combination thereof may be communicated via the social network hosted by the social media server 114. For example, the player inquiry may be communicated to the geocache module 130 via the social media server 114. In response, the identity of the actual benefit may be communicated via the social media server 114. For instance, the identity of the actual benefit may be posted in an information feed of the player 102. In addition, when the player 102 locates the geoseed or enters the area surrounded by the digital fence, the confirmation may be communicated to the geocache module 130 via the social media server 114.

The verification information may include geoseed identifying information, a digital code, a picture of the geoseed, and redemption of the actual benefit. The geoseed identifying information may include a specific word, a specific phrase, serial number, a name, and the like. The digital code may include an alpha-numeric code, a numeric code, a binary code, a quick response (QR) code, a bar code, and the like. The geoseed identifying information and/or the digital code may be communicated to the geocache server 116 using the device 104. For instance, the player 102 may type the geoseed identifying information and/or the digital code into a user interface provided via the client module 120 or the website 126. The digital code may also be scanned or photographed. The scanned or photographed digital code may then be communicated to the geocache server 116. In some instances, the geoseed may include a coin, for instance, that does not include a digital code or the geoseed identifying information. In these instances, the player 102 may take a picture of the geoseed. The picture may be communicated to the geocache server 116 in a confirmation signal.

In some embodiments, the confirmation signal may be communicated when the player redeems the actual benefit. For example, the actual benefit may be placed inside the geocache. When the player 102 locates the geocache, the player 102 may take the actual benefit. The player 102 may then redeem the actual benefit, which may indicate to the geocache server 116 that the player 102 located the geocache.

In circumstances in which the player 102 is locating a digital fence, the device 104 may include a system that determines the physical location of the device 104. For example, the device 104 may include a GPS receiver. In response to the device 104 (and thus the player 102) entering the area surrounded by the digital fence, the device 104 may communicate a confirmation signal including locational data of the device 104. In some embodiments, the locational data and/or the confirmation signal may be at least partially generated and/or communicated by the client module 102 via the network 140.

The geocache module 130 may be configured to authenticate the verification information. For example, the geocache module 130 may store a verification information record that identifies verification information of one or more of the geoseed. The geocache module 130 cross-checks the received verification information with that in the verification information record.

In some embodiments, the geocache module 130 may also communicate to the device 104 of the player 102 a message indicating that the player 102 is entitled to the actual benefit. For example, in response to a determination that the player 102 has physically entered the area surrounded by the digital fence, the geocache module 130 may communicate a message to the player indicating that the player is entitled to the actual benefit.

The geocache module 130 may be configured to award to the player 102 the identified actual benefit. For example, the geocache module 130 may apply a financial credit to a personalized account of the player 102 or mail the actual benefit to the player 102. Additionally or alternatively, the geocache module 130 may enable access to the actual benefit. For example, the geocache module 130 may send a digital representation of the actual benefit to the device 104 of the player 102 or send a message to the advertiser 124 via the network 140 authorizing access to the actual benefit.

In some embodiments, the awarding of the identified actual benefit may be performed via the social media server 114. For example, a coupon code, a link, receipt, etc. may be posted to a social media account of the player 102.

The ad module 132 may be configured to communicate or to otherwise provide access to at least some portion of the player information 128 and the game information 142 to the advertiser 124. For example, the advertiser 124 may want access to the player information 128 and/or the game information 142 to determine if and what amount to bid on a geoseed or digital fence. Additionally, the advertiser 124 may want access to the player information 128 and/or the game information 142 to determine a suitable actual benefit to provide in exchange for locating a geoseed or entering an area surrounded by a digital fence.

The ad module 132 may receive a bid from the advertiser 124 to sponsor the geoseed or an area surrounded by a particular digital fence. For example, the ad module 132 may host or facilitate an auction in which bids are submitted to sponsor geoseed and/or digital fences. The ad module 132 may accept the bid from the advertiser 124 may reject the bid from the advertiser 124. In response to accepting a bid of the advertiser 124, the ad module 132 may associate a sponsorship of the geoseed or the digital fence with the advertiser 124.

Additionally, in some embodiments, the ad module 132 may receive an indication of the actual benefit from the advertiser 124. The ad module 132 may then communicate the actual benefit to the geocache module 130. The actual benefit may include an object placed in a geocache. For example, the actual benefit may include a T-shirt having a logo of the advertiser 124 printed on it. Accordingly, the ad module 132 may provide coordinates of the geoseed, the geocache, or the digital fence to the advertiser to enable placement of the actual benefit in the geocache or the digital fence.

The game module 134 may be configured to host and support games in the geocaching environment 100. In some embodiments, the games hosted or supported by the game module 134 may include computer-based games that do not interact with the social network during play. For instance, the player 102 may participate in the game as an individual without necessarily interfacing with other devices via the network 140 on a continuous basis. Some portion of the data generated during play may be posted or otherwise shared. In some embodiments, the games hosted or supported by the game module 134 may interact with multiple client modules 120 via the network 140 or may interact with multiple client modules 120 via the social network.

The game module 134 may be accessed by the other components of the geocaching environment 100 directly or via, the network 140. The player 102 may use the device 104 to access, send data to, and receive data from the website 126, the social media application 138, the game module 134, or any combination thereof to participate in the games. In some embodiments, the game module 134 and/or the social media game module 150 may include an introduction mechanic that can introduce the players 102 to the games on the game module 134 and to other players 102 engaged with the game module 134, or provide help when encountering a common in-game obstacle.

The games hosted or supported by the game module 134 and the social media games hosted or supported by the social media game module 150 may include multiple game actions. The game actions include any step or play performed by the players 102 in furtherance of the games and/or the social media games. The game and/or the social media game may include one or more virtual game actions and one or more actual game actions.

The actual actions may be performed in a real-world environment. For example, the actual actions may include a player 102 finding a geocache or entering a fence. The virtual game actions are generally performed in a virtual environment and may be performed through communication of digital data via the network 140 or between components of the geocaching environment 100. For example, virtual game actions can include progress in the game through participation and interaction with the virtual environment created in the game. Similarly, the virtual game actions can include progress in the social media game through participation and interaction with the virtual environment created in the social media game.

The games and/or the social media games may be developed based upon a treasure hunting theme or another theme such as an exploration theme, a quest theme, and the like. The games and/or the social media games may include multiple levels, hidden accesses, and the like. In some embodiments, to achieve the multiple levels and/or hidden accesses, codes may be employed that may involve the player 102 to perform one or more game actions. Complexity of the game actions may range from menial to complex.

In an example of an actual action, a geocache may include an item such as a portion of the clues that may be used in the game. The game module 134 or the social media game module 150 may prompt the player 102 for information included in the item. After the player 102 has entered the information, the game module 134 or the social media game module 150 may enable the player to perform one of the one or more virtual potential game actions based on the information included in the item.

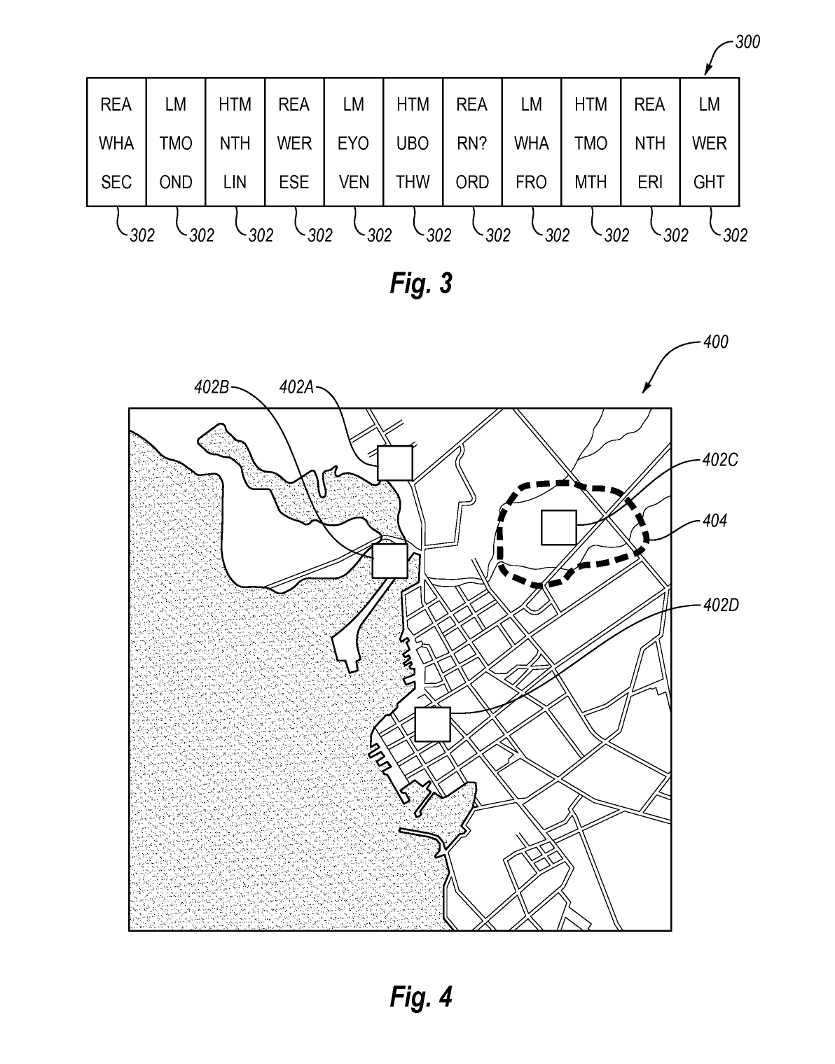

With combined reference to FIGS. 1 and 3, game actions may include deciphering a set of clues 300 contained in multiple geoseeds. In this example, a group of geoseeds may each include one clue portion 302 of the set of clues 300. The clue portions 302 may be hidden on a card in some instances. When the player 102 locates the set of clues 300, a code may be deciphered. The code may be used in the game to receive points, to advance in the game, or take some game action.

For example in the set of clues 300 the code may include:

REALM.HTM

WHAT MONTH WERE YOU BORN?

SECOND LINE SEVENTH WORD FROM THE RIGHT

After the code is deciphered, the deciphered code may be used in the game or the social media game as a question. The question may incorporate the player information 128, which may allow answers to be specific to the player 102. The game module 134 may match an answer input to the player information 128. For example, in response to the deciphered code above, the player 102 may enter the month of birth of the player 102. The answer to the deciphered code may be entered into the website 126, the game module 134, the social network, or any combination thereof. A correct answer may allow the player 102 to advance, gain points, or receive numerous other benefits in the game.

Additionally, the deciphered code may be used as a question relevant to the geoseed. For instance, the third sentence “SECOND LINE SEVENTH WORD FROM THE RIGHT” may refer to a disclaimer statement. The disclaimer statement may be printed on a back of a card on which one or more of the clue portions 302 are printed. In this case, the answer may be “card,” and the disclaimer statement may include:

Disclaimer Statement
Holder of this card is not required to purchase any business materials or services in order to use this card. CodeGeo does not warrant the function or use of this card.

As above, an answer to the deciphered code may be entered into the website 126, the game module 134, the social network, or any combination thereof. A correct answer may allow the player 102 to advance, gain points, or receive numerous other benefits in the game.

Additionally, the deciphered code may progress the player 102 through the game. For example, the above deciphered code “REALM.HTM” may be configured to open a new website page. When the player 102 discovers that “REALM.HTM” opens a new website page, the player 102 may open the website page. The website page may include fields including: a player name, a card serial number, and a card code. When the player 102 correctly enters the clues/questions into the fields, the new website can open another webpage that appears to be a blog between two users. The blog may appear to be a conversation discussing a treasure and an additional clue to a location of the treasure. The player 102 may proceed to find the treasure and advance in the game. Thus, the code decipher process may be one way in which a game administrator may create multiple levels of the game.

The clue portions 302 may be digitally generated by devices such as one time password (OTP) devices. Additionally, the clue portions 302 may be printed with thermo-graphic ink. Additional technologies and techniques can be employed inspiring the player 102 to continue her search, provide the sense of urgency, and extend the length of the game.

Referring back to FIG. 1, another game or social media game may include a contest that is played by integrating information from geoseeds, identification (ID) cards, multiple real-world sources, or some combination thereof with a virtual environment of an online game which may incorporate the social media game. In the online game, the players 102 compete to earn points. The players 102 may be ranked based on a total number of points and/or a level of achievement the player 102 has obtained. In addition, the players 102 may be allowed to select a sponsor from a set of advertisers (e.g., the advertiser 124). The players 102 may earn points, which may contribute to totals for ranking. The sponsors may have flexibility regarding how to award the players 102 that have selected them.

The online game may include an adventure in which multiple players 102 accumulate virtual benefits and actual benefits through location of geocaches and through participation in one or more of the games hosted by the game module 134 or the social media game. For example, the player 102 may also choose to participate in an adventure. The adventure may include solving numerous puzzles; participating in live interactive games; or answering timed questions. The player 102 may gain points for the games and/or puzzles as well as how many geoseeds the player 102 has found or planted and/or how far an individual geoseed has traveled. In some embodiments, the puzzles and codes that the player 102 uncovers may lead the player 102 to coordinates of other geocaches.

In these and other embodiments, the game module 134 may be further configured to identify a virtual benefit that is provided for locating the geoseed, for performing a game action, entering an area surrounded by a digital fence, or any combination thereof

The game module 134 and the social media game module 150 may also be configured to update the player information 128 of the player 102 to reflect the virtual benefits. Additionally or alternatively, the game module 134 may be configured to post some portion of the updated player information 128 to a social network and/or integrate information posted in an information feed of the player 102 into the player information 128.

In some implementations, the geocache server 116 may include the website 126 which may be configured specifically for geocaching, gaming, providing actual benefits to the players 102, and including advertising in the geocaches and/or digital fences. For example, the website 126 may include a user interface created for or otherwise supporting communication of information in the geocaching environment 100. The website 126 may be further configured to provide to the player 102 and/or the advertiser 124 an interface via a browser.

The website 126 may further provide the login page to the players 102. The website 126 may enable the players 102 to find and obtain benefits (actual or virtual) of the geoseed and/or communicate information to the geocache server 116 as described herein. The website 126 may require a periodic (e.g., weekly, annual, or monthly) membership. Additionally or alternatively, the website 126 may be accessible via an electronic activation key that may involve the player 102 solving and unlocking one or more games and/or puzzles, for instance.

In some embodiments, the players 102 and/or an advertiser 124 may be issued an ID card. The ID card may be used as a membership card for access to the website 126. The ID card may contain user information specific to the player 102 or the advertiser 124. The ID card may also provide an additional level of security required to access the website 126. Additionally, the ID card can be used to unlock and/or access certain geocaching game features or levels. Game-related characteristics may also be enhanced by leveraging the ID card in conjunction with information located on a geoseed, which may result in player-specific benefits. The ID cards may also be personalized to contain graphics provided by the player 102 and/or the advertiser 124.

In some embodiments, the geocache environment 100 may include an online server 160. The online server 160 may include a hardware server that includes a processor, memory, and network communication capabilities. In the illustrated implementation, the online server 160 is coupled to the network 140. The online server 160 may send and receive data to and from one or more of the devices 104, the geocache server 116, the social media server 114, and the third party server 112 via the network 140. The online server 160 may create at least partially an online environment in which the player may interact. For example, the online environment may include a retail website, a rating website, a media website, a search website, or any other similar website.

In some embodiments, the player 102 may interact with the online server 160 using the device 104, for instance. During interactions of the player 102 in the online environment created by the online server 160, online actions of the player 102 may be identified by one or more of the geocache server 116, the social media server 114, and the third party server 112. The virtual benefit and the actual benefit may be based at least partially on the online action. Some examples of the online actions may include an online purchase of a product, a submission of a review by the player, a viewing of online media content, and a view of an advertisement or a sponsored web link.

Modifications, additions, or omissions may be made to the geocaching environment 100 without departing from the scope of the present disclosure. Specifically, embodiments depicted in FIG. 1 include one third party server 112, one online server 160, one social media server 114, one geocaching server 116, and two devices 104. However, the present disclosure applies to a geocaching environment 100 that may include multiple third party servers, multiple online servers, multiple social media servers, multiple geocaching servers, two or more devices, or any combination thereof. Moreover, the separation of various components in the embodiments described herein is not meant to indicate that the separation occurs in all embodiments. Moreover, it may be understood with the benefit of this disclosure that the described components may be integrated together in a single component or separated into multiple components.

The client module 120, the social media application 138, the geocache module 130, the game module 134, and the ad module 132 may include code and routines for performing the operations discussed herein. In some embodiments, one or more of the client modules 120, the social media application 138, the geocache module 130, the game module 134, and the ad module 132 act in part as a thin-client application that may be stored on a computing device and in part as components that may be stored on one or more hardware servers, for instance. In some embodiments, the client module 120, the social media application 138, the geocache module 130, the game module 134, the ad module 132, or any combination thereof may be implemented using hardware including a field-programmable gate array (FPGA) or an application-specific integrated circuit (ASIC). In some other instances, the client module 120, the social media application 138, the geocache module 130, the game module 134, the ad module 132, or any combination thereof may be implemented using a combination of hardware and software.

In the geocaching environment 100 or any component (e.g., 104, 112, 114, 160, 116) thereof, memory such as the memory 122, may include a non-transitory memory that stores data for providing the functionality described herein. The memory may be included in storage that may be a dynamic random access memory (DRAM) device, a static random access memory (SRAM) device, flash memory, or some other memory devices. In some embodiments, the storage also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

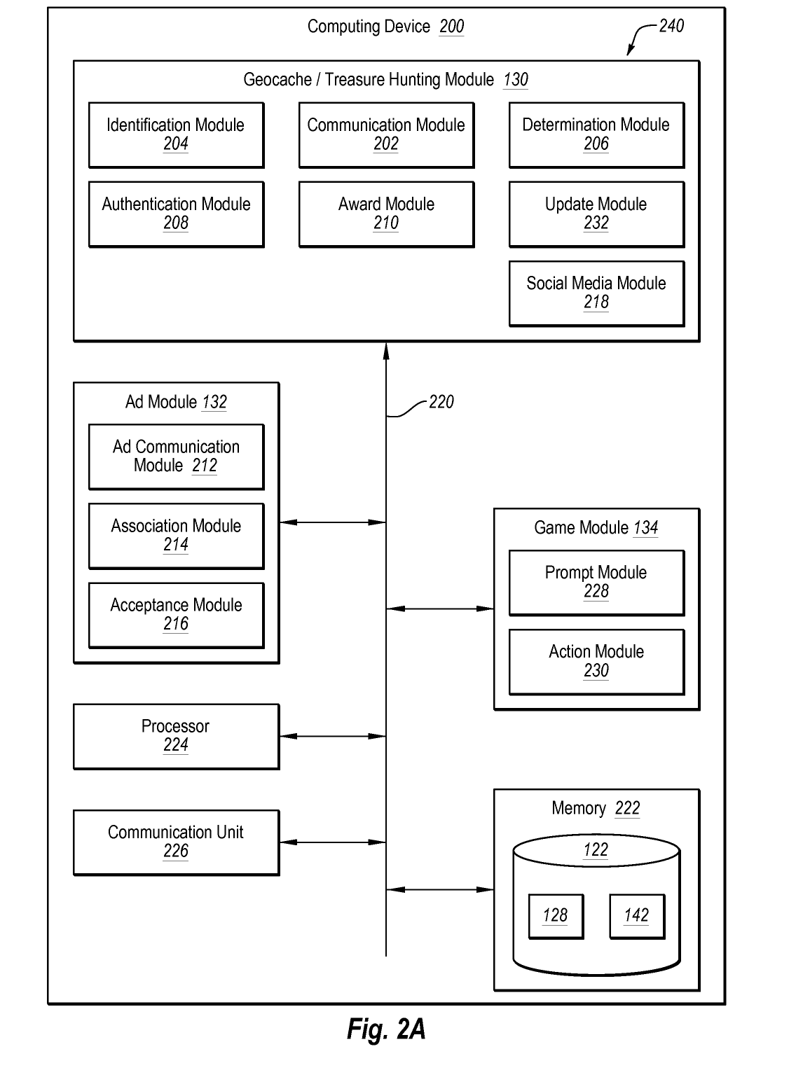

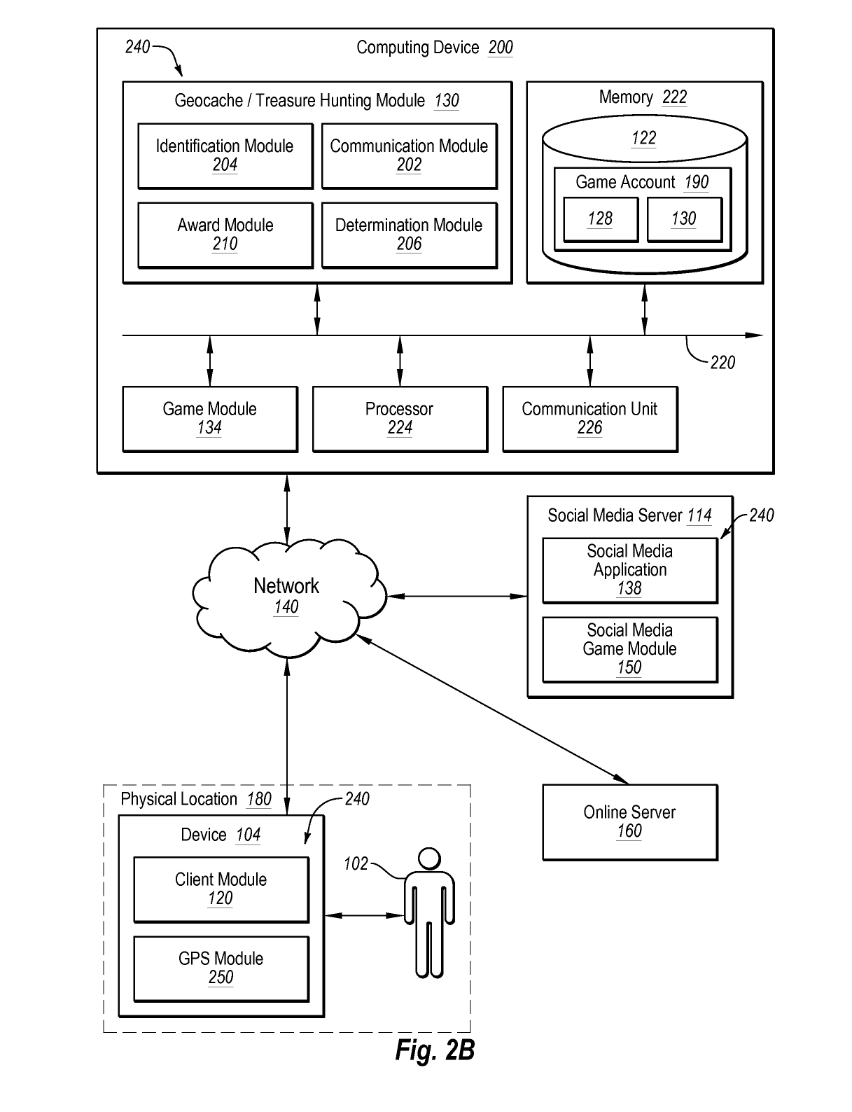

Referring now to FIGS. 2A and 2B, examples of the geocache module 130, the game module 134, the ad module 132, the social media server 114, and the device 104 are shown in more detail. With reference to FIG. 2A, a computing device 200 may include the geocache module 130, the game module 134, the ad module 132, a processor 224, a memory 222, and a communication unit 226. FIG. 2B includes the computing device 200 that includes the geocache module 130, the game module 134, the processor 224, the memory 222, and the communication unit 226. The components of the computing device 200 may be communicatively coupled by a bus 220. The computing device 200 may include the geocache server 116 of FIG. 1 in some embodiments.

With combined reference to FIGS. 1, 2A, and 2B, the processor 224 may include an arithmetic logic unit (ALU), a microprocessor, a general-purpose controller, or some other processor array to perform one or more operations described herein. The processor 224 may be coupled to the bus 220 for communication with the other components (e.g., 130, 132, 134, 222, 224, and 226). The processor 224 generally processes data signals and may include various computing architectures including a complex instruction set computer (CISC) architecture, a reduced instruction set computer (RISC) architecture, or an architecture implementing a combination of instruction sets. Although FIGS. 2A and 2B include a single processor 224, multiple processors may be included in the computing device 200. Other processors, operating systems, and physical configurations may be possible.

The memory 222 may be configured to store instructions and/or data that may be executed by the processor 224. The memory 222 may be coupled to the bus 220 for communication with the other components. The instructions and/or data may include code for performing the techniques or methods described herein. The memory 222 may be a DRAM device, an SRAM device, flash memory, or some other memory device. In some embodiments, the memory 222 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis. In the depicted embodiment, the memory 222 includes the memory 122. The memory 122 may be configured to store and/or enable access to the game information 142 and/or the player information. In some embodiments, the memory 122 or some portion thereof may be located remotely and accessed via the network 140.

The communication unit 226 may be configured to transmit and receive data to and from other systems. For example, the communication unit 226 may enable communication via the network 140 with the devices 104, the third party server 112, the social media server 114, and the geocache server 116, depending on implementation of the computing device 200. The communication unit 226 may be coupled to the bus 220. In some embodiments, the communication unit 226 includes a port for direct physical connection to the network 140 or to another communication channel. For example, the communication unit 226 may include a USB, SD, CAT-5, or similar port for wired communication. In some embodiments, the communication unit 226 includes a wireless transceiver for exchanging data via communication channels using one or more wireless communication methods, including IEEE 802.11, IEEE 802.16, BLUETOOTH®, or another suitable wireless communication method.

In some embodiments, the communication unit 226 includes a cellular communications transceiver for sending and receiving data over a cellular communications network including via SMS, MMS, hypertext transfer protocol (HTTP), direct data connection, WAP, email, or another suitable type of electronic communication. In some embodiments, the communication unit 226 includes a wired port and a wireless transceiver. The communication unit 226 may also provide other conventional connections for distribution of files and/or media objects using standard network protocols including transmission control protocol/internet protocol (TCP/IP), HTTP, HTTP secure (HTTPS), and simple mail transfer protocol (SMTP), etc.

In the embodiment of FIG. 2A, the geocache module 130 includes an identification module 204, a communication module 202, a determination module 206, an authentication module 208, and an award module 210, an update module 232, and a social media module 218. The ad module 132 may include an ad communication module 212, an association module 214, and an acceptance module 216. The game module 134 may include a prompt module 228 and an action module 230. The modules (e.g., 130, 132, 134, 202, 204, 206, 208, 210, 212, 214, 216, 218, 228, 230, and 232) are collectively, referred to as the modules 240.

In both FIGS. 2A, and 2B, one or more of the modules 240 may be implemented as software including one or more routines configured to perform one or more operations. The modules 240 may include a set of instructions executable by the processor 224 to provide the functionality described herein. In some instances, the modules 240 may be stored in or at least temporarily loaded into the memory 222 of the computing device 200 and may be accessible and executable by the processor 224. One or more of the modules 240 may be adapted for cooperation and communication with the processor 224 and components of the computing device 200 via the bus 220.

With reference to FIG. 2A, the ad communication module 212 may be configured to handle communications between the ad module 132 and other components of the computing device 200 (e.g., 130, 134, 222, 224, and 226). The ad communication module 212 may be configured to send and receive data via the communication unit 226 to outside systems (e.g., via the network 140). In some instances, the ad communication module 212 may cooperate with the other modules 240 to receive and/or forward, via the communication unit 226, data from the components. For example, the ad communication module 212 to communicate a portion of the player information 128 and the game information 142 to the advertiser 124. The advertiser 124 may use the player information 128 and the game information 142 as bases for bids.

The ad communication module 212 may receive a bid from the advertiser 124. The bid may include a bid to sponsor a geoseed, a set of geoseeds, an area surrounded by the digital fence, one or more of the players 102, and the like. The ad communication module 212 may communicate the bid to the acceptance module 216.

The acceptance module 216 may be configured to receive bids and determine whether to accept a bid. In some embodiments, the acceptance module 216 may accept the bid from the advertiser 124 to sponsor the geoseed, the set of geoseeds, the area surrounded by the digital fence, one or more of the players 102, and the like. The acceptance module 216 may communicate a signal indicating acceptance of the bid to the association module 214.

The association module 214 may be configured to receive the signal indicating acceptance of the bid and associate the sponsorship of the advertiser 124 and the geoseed, the set of geoseeds, the area surrounded by the digital fence, one or more of the players 102, and the like. The ad communication module 212 may then receive an indication of the actual benefit provided by the advertiser 124 for locating of the geoseed, the set of geoseeds, the area surrounded by the digital fence, and the like. The ad communication module 212 may communicate coordinates to the advertiser 124. The advertiser 124 may then place the actual benefits in the geocache(s) and/or within the digital fence(s).

The communication module 202 may be configured to handle communications between the geocache module 130 and other components of the computing device 200 (e.g., 132, 134, 222, 224, and 226). The communication module 202 may be configured to send and receive data via the communication unit 226 to outside systems (e.g., via the network 140). In some instances, the communication module 202 may cooperate with the other modules 240 to receive and/or forward, via the communication unit 226, data from the components. For example, the communication module 202 to receive a player inquiry. The player inquiry may be communicated via the network 140 to the communication unit 226. The player inquiry may then be communicated to the communication module 202 via the bus 220. In response to the player inquiry, the communication module 202 may communicate coordinates of a geocache and/or a digital fence. The coordinates of the geocache and/or the digital fence may be stored in the memory 222, for instance. The coordinates of the geocache and/or the digital fence may be communicated to the device 104 of the player 102 via the bus 220, the communication unit 226, and the network 140. The geocache may include a geoseed that is sponsored by the advertiser 124. The communication module 202 may communicate a signal indicating that the coordinates have been communicated to the identification module 204.

The identification module 204 may be configured to identify an actual benefit provided for locating the geoseed or entry into an area surrounded by the digital fence. The identification of the actual benefit may include communicating a message to the player 102 at the time of the player inquiry and/or communicating a message to the player 102 after the player 102 has located the geocache or entered the area surrounded by the digital fence. The communication module 202 may communicate the message to the player 102. The actual benefit may be associated with the advertiser 124 that sponsors the geoseed in the geocache or the area surrounded by the digital fence.

The communication module 202 may then receive a confirmation signal indicating the player 102 has located the geocache or entered the area. The confirmation signal may include verification information specific to the geoseed, for example. The communication module 202 may communicate the confirmation signal to the authentication module 208 and the update module 232.

The authentication module 208 may be configured to receive the confirmation signal from the communication module 202 and authenticate the verification information. The verification information may include, but is not limited to, geoseed identifying information, a digital code, a picture of the geoseed, and redemption of the actual benefit. Accordingly, the authentication module 208 may be configured with one or more subroutines that authenticate the verification information such as image analysis techniques, comparison tools, and the like. Moreover, the authentication module 208 may be communicatively coupled with a system that may identify redemption of the actual benefit. The authentication module 208 may then communicate a signal indication authenticity of the confirmation signal to the award module 210.

The update module 232 may be configured to receive the confirmation signal and update seeking information. In some embodiments, the update module 232 may update the player information 128 of the player 102 to reflect an actual benefit and/or a virtual benefit. The update module may communicate the updated player information 128 to the social media module 218. The social media module 218 may be configured to receive the updated player information and post some portion of the updated player information to the social network.

The award module 210 may be configured to receive signals indicating authenticity of confirmation signals and to award to the player 102 the identified actual benefit. In some embodiments, the award module 210 may communicate the actual benefit to the player 102 via the communication module 202. Additionally or alternatively, the award module 210 may communicate a message to the third party server 112, the device 104, or another outside system that enables the player 102 access to the actual benefit. For example, the actual benefit may include a gift card or a store credit. Use of the gift card or the store credit may involve activation. The award module 210 may communicate a message that activates the gift card or the store credit.

Additionally or alternatively, the communication module 202 may be configured to receive a player inquiry for an area surrounded by a digital fence. In response to the player inquiry, the communication module 202 may communicate coordinates of the digital fence. The area surrounded by the digital fence may be sponsored by the advertiser 124. The coordinates may be communicated via the bus 220, the communication unit 226, and the network 140. The communication module 202 may also communicate a signal to the identification module 204 indicating the coordinates of the digital fence have been communicated.

The identification module 204 may be configured to identify a second actual benefit that is provided for physically entering the area surrounded by the digital fence. The digital fence may be configured by a host or the advertiser 124. The identification of the actual benefit may include communicating a message to the player 102 at the time of the player inquiry and/or communicating a message to the player 102 after the player 102 has entered the area surrounded by the digital fence.

The determination module 206 may be configured to determine whether the player 102 has physically entered the area. In some embodiments, the determination module may determine whether the player 102 has physically entered the area based on locational data received from a mobile device such as the device 104 associated with the player 102. In response to a determination that the player 102 has physically entered the area, the determination module 206 may communicate a signal to the communication module 202 and the award module 210 indicating the player 102 has physically entered the area surrounded by the digital fence. The communication module 202 may communicate a message to the player 102 indicating that the player 102 is entitled to the second actual benefit. The award module 210 may then award to the player 102 the second actual benefit or enable access to the second actual benefit.

In some embodiments, the identification module 204 may be configured to identify a virtual benefit. The identification of the virtual benefit may include communicating a message to the player 102 at the time of the player inquiry and/or communicating a message to the player 102 after the player 102 has located the geocache. The communication module 202 may communicate the message to the player 102. The virtual benefit may be configured for use in a game involving geocaching. The game may include one or more virtual game actions performed through communication of digital data via the network 140 and one or more actual game actions performed in a real-world environment.

The geocache may have placed therein an item used in the game. In these and other embodiments, the prompt module 228 may be configured to prompt the player 102 for information included in the item. The prompt module 228 may communicate the information from the item to the action module 230.

The action module 230 may be configured to receive the information from the item and enable the players 102 to perform one or more game actions in the game. For example, the action module 230 may enable the player 102 to perform virtual game actions based on the information included in the item.

With reference to FIG. 2B, the computing device 200 is depicted with the network 140, the device 104, the online server 160, and the social media server 114. In the depicted embodiment, the device 104, the social media server 114, and the computing device 200 may communicate information and data via the network 140. The device 104 may be located at a physical location 180. The physical location 180 may include any geographic location. In most circumstances, the physical location 180 remotely located with respect to the computing device 200, the social media server 114, and the online server 160.

In some embodiments, the identification module 204 may be configured to identify a proposed action to be performed by the player 102. For example during interaction of the player 102 in a virtual environment of a game hosted by the game module 134 or a social media game hosted by the social media server 116, the identification module 204 may be configured to identify a proposed action. The proposed action may include any game action. For example, the proposed action may include a virtual action that may be taken in the virtual environment of the social media game or the game. Additionally, the proposed action may include an actual action that may be performed in the real-life environment such as locating a geocache or entering a digital fence.

The identification module 204 may be configured to identifying the player 102. For example, the identification module 204 may identify the player 102 based on a login or an account. The login may include a login used to access the geocache module 130 or a social media account used to interface with a social network hosted by the social media application 138.

The determination module 206 may be configured to determine a virtual benefit and/or an actual benefit. As described elsewhere herein, the virtual benefit may include advancement in the game or the social media game. The actual benefit may include a coupon, a gift card, a product, a discount, and the like. The virtual benefit and/or the actual benefit provided to the player 102 for completion of the proposed action. The determination module 206 may determine the virtual benefit and/or the actual benefit based the identification of the proposed action and player information 128 associated with the player 102.

In some embodiments, the determination module 206 may determine the virtual benefit and/or the actual benefit based on one or more of a frequency of play of the game or the social media game, a duration of the play, a play preference of the player 102, a category of actual awards selected by the player 102, an amount of time until the player performs the proposed action, or some combination thereof.

In some embodiments, the communication module 202 may be configured to access a game account 190 of the player 102. The game account 190 may include the player information 128 and the game information 142. From the game account 190, the identification module 204 may identify game information 142 of the player 102 in the game or the social media game associated with the player 102. The determination module 206 may determine the virtual benefit and the actual benefit based on the game information 142. For example, the virtual benefit and the actual benefit may be based at least partially on a player character and in-game assets.

The communication module 202 may be configured to present the proposed action to the player 102. For example, the communication module 202 may present the proposed action to the player 102 via the network 140 and the device 104. Additionally or alternatively, the communication module 202 may present the proposed action via the social media server 114 such that the proposed action appears in an information feed of the player 102.

The player 102 may receive the presented proposed action via the client module 120 and/or the social media application 138. In response, the player 102 may generate and communicate an acceptance to the computing device 200. The communication module 202 may receive the acceptance of the proposed action. The player 102 may perform the proposed action. For example, the player 102 may accomplish some goal in the game or the social media game. Additionally or alternatively, the player 102 may locate a geocache or enter a digital fence. The player 102 may generate a confirmation indicating the performance of the proposed action. The confirmation may be generated by the client module 120 and/or the social media application 138. The confirmation may be communicated to the computing device 200.

The communication module 202 may receive the confirmation. In response to the confirmation, the communication module 202 may reveal the virtual benefit and/or the actual benefit to the player 102. For example, after the player performs the proposed action, the communication module 202 may reveal the virtual benefit via the device 104 or the social network. In some embodiments, the communication module 202 may reveal virtual benefit and/or the actual benefit with the proposed action. Additionally, in response to the confirmation, the award module 210 may be configured to award the virtual benefit and the actual benefit to the player 102.

In some embodiments, the player 102 may interact with the online server 160. During interactions of the player 102 in the online environment created by the online server 160, the identification module 204 may be further configured to identify an online action of the player 102. The identified online action may be communicated to the determination module 206. The determination module 206 may determine the virtual benefit and the actual benefit are based at least partially on the online action. Some examples of the online actions may include an online purchase of a product, a submission of a review by the player, a viewing of online media content, and a view of an advertisement or a sponsored web link.

With continued reference to FIG. 2B, in another example embodiment, the computing device 200 may be configured to communicate one or more location-based actions to the player 102. In these and other embodiments, the identification module 204 may be configured to identify the player 102 based on a received message. The device 104 may be configured to generate the received message, which may be communicated to the computing device 200. The player 102 may be associated with the device 104, which may enable the identification of the player 102 from the received message generated by the device 104. Additionally, the determination module 206 may be configured to determine a physical location of the device 104 based on the received message.

The received message may include GPS coordinates of a physical location 180 of the player 104 at the time the received message is generated. Additionally or alternatively, the received message may include an indication that the player 102 has purchased an item at the physical location 180. Additionally in some embodiments, the received message may be automatically generated at the device 104 based on a proximity of the device 104 to the physical location 180. The communication module 202 may access the player information 128 associated with the player 102. From the player information 228, the identification module 204 may identify a game or a social media game associated with the player 102.

The determination module 206 may determine a location-based action for the player 102. The location-based action may be performed at the physical location 180. Some examples of the location-based action may include purchasing an item at the physical location, spending a specified amount of legal currency at a location related to the location-based action, locating a pet seed at a location related to the location-based action, spending a specified amount of legal currency at a location related to the location-based action, and visiting a location related to the location-based action.

The determination module 206 may determine the location-based action based on one or more of the attributes of the physical location 180. In some embodiments, the attributes include types of items available at a location related to the location-based action or to the physical location 180, demographics of visitors of a location related to the location-based action or to the physical location 180, a geography of an area surrounding a location related to the location-based action or to the physical location 180, activities performed at a location related to the location-based action or to the physical location 180, duration of activities performed at a location related to the location-based action or to the physical location 180, a brand or a trademark associated with a location related to the location-based action or to the physical location 180, and weather at a location related to the location-based action or to the physical location 180.

The determination module 206 may also determine a virtual benefit and an actual benefit to be provided to the player 102 for completion of the location-based action. Determination of the virtual benefit and the actual benefit being based on the location-based action and the game or social media game associated with the player 102.

In some embodiments, the communication module 202 may access a game account 190 of the player 102. From the game account 190, the identification module 204 may identify game information 142 of the player 102 in the game or the social media game associated with the player. In these and other embodiments, determination of the location-based action, the virtual award, the actual award, or some combination thereof may be further based on the game information 142.

The communication module 202 may transmit to the device 104 a description of the location-based action, a description of the virtual benefit and the actual benefit, and an offer of the virtual benefit and the actual benefit for performance of the location-based action. In some embodiments, the transmission may include a posting in an information feed of the player 102 in a social network and/or a message communicated to the device 104 via the network 140.

The player 102 may perform the location-based action. The player 102 may generate a confirmation indicating the performance of the location-based action. The confirmation may be generated by the client module 120 and/or the social media application 138. The confirmation may be communicated to the computing device 200.

In some embodiments, the confirmation may include GPS coordinates of the device 104 generated by a GPS module 250. The GPS coordinates may indicate that the player 102 has performed the location-based action, a numerical code obtained from a location related to the location-based action, a scannable code obtained from a location related to the location-based action, a proof of purchase, or some combination thereof

The communication module 202 may receive the confirmation. In response to the confirmation, the award module 210 may be configured to award the virtual benefit and the actual benefit to the player 102.

FIG. 4 illustrates an example map 400 that may be provided in the geocaching environment 100 of FIG. 1. With combined reference to FIGS. 1 and 4, the map 400 may be provided to the player 102 at the client module 120 and/or via the website 126. The map 400 may include locations of geocaches 402A-402D (generally, geocache 402 or geocaches 402) and a location of a digital fence 404. The geocaches 402 may include containers such as a letterbox, a treasure box, ammunition boxes, etc. The geocaches 402 may be distributed throughout a geographical area depicted in the map 400. The player 102 or an administrator may hide the geocaches 402 at specific coordinates. The coordinates may then be communicated to the geocache server 116 and indicated on the map 400. Additionally, the player 102 may re-hide one of the geocaches 402 after the player 102 locates the geocache 402. A new location may be communicated to the geocache server 116 and indicated on the map 400.

The digital fence 404 may be assigned by an administrator and/or the advertiser 124. The digital fence 404 may surround a general physical area of interest, a geocache (e.g., 402C in FIG. 4), a location relevant to the advertiser 124 (e.g., a store or location of an event), or some combination thereof. The digital fence 404 may be identified by a GPS location with or without a perimeter. The geometry of the digital fence 404 can be of any geometric shape such as a circle, a square, or any multi-sided configuration. The geometry may be based upon a time-related activity. For instance, the geometry may be based upon a time to travel within the digital fence 404, a time to travel across the area surrounded by the digital fence 404, a time to a center of the area surrounded by the digital fence 404, or a time to travel around the area surrounded by the digital fence 404. When the device 104 comes within the digital fence 404, the player 102 may be notified by and interact with the website 126, the geocache server 116, or another component of the geocaching environment 100.

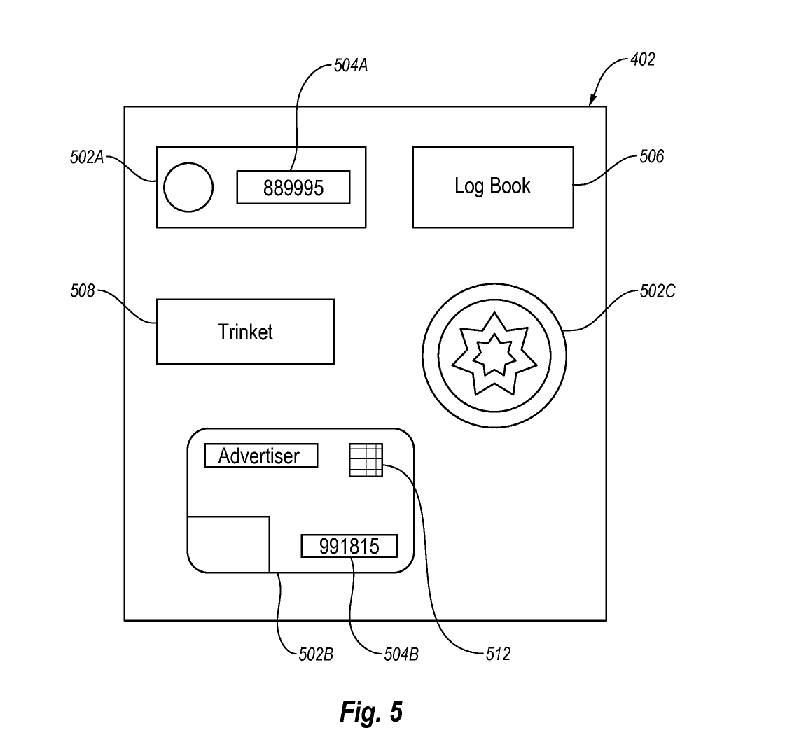

FIG. 5 illustrates an example of the geocache 402 that may be implemented in the geocaching environment 100 of FIG. 1. The geocache 402 may include one or more geoseeds 502A-502C (generally, geoseed 502 or geoseeds 502) that integrate advertising and gaming. The geoseeds 502 may include an electronic device geoseed 502A, a card geoseed 502B, and a coin geoseed 502C. The electronic device geoseed 502A and the card geoseed 502B may include card numbers 504A and/or 504B, which may be used as verification information. The card geoseed 502B may also include a digital code 512 incorporated in a QR code. In some embodiments, the card geoseed 502B may be an actual benefit in that it may be the card geoseed 502B that can be used in a transaction.

The coin geoseed 502C may not contain a card number. To use the coin geoseed 502C, a player can take a picture of the coin geoseed 502C and communicate the picture to a geocaching server such as the geocaching server 116. Image analysis may be performed on the picture of the coin geoseed 502C to determine that the player is in possession of the coin geoseed 502C. One or more of the geoseeds 502 may include information used in a game.

The geocache 402 may also have placed therein a logbook 506 and one or more trinkets 508. The trinkets 508 may include key chains or small toys. The player may sign and date the logbook 506 to record her visit. The player may then take the trinket 508 and leave another trinket in the geocache 402. Some other examples of the trinket 508 can include toys, key chains, coins, tokens, and the like.

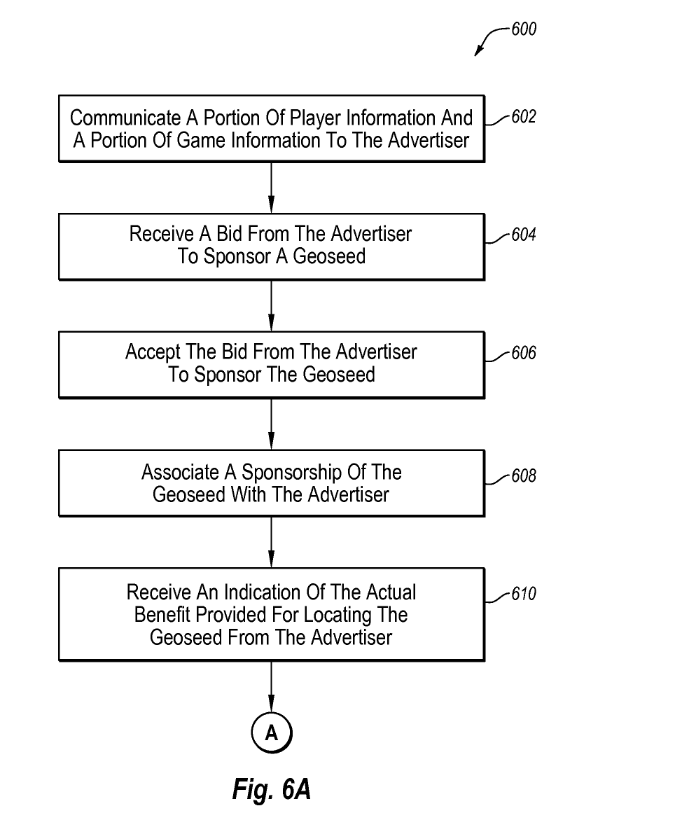

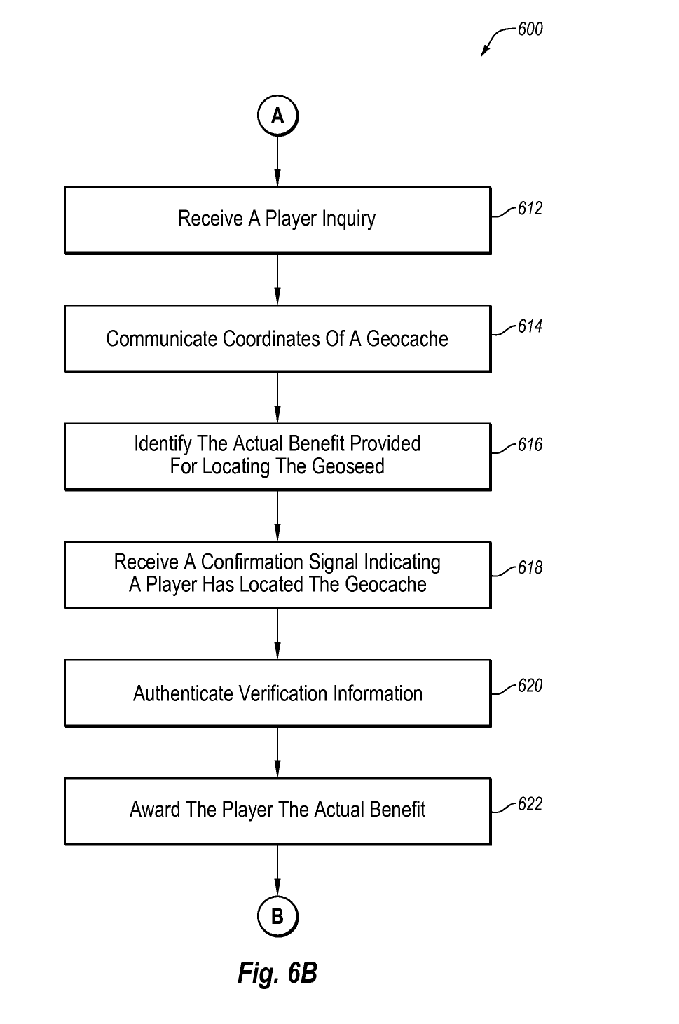

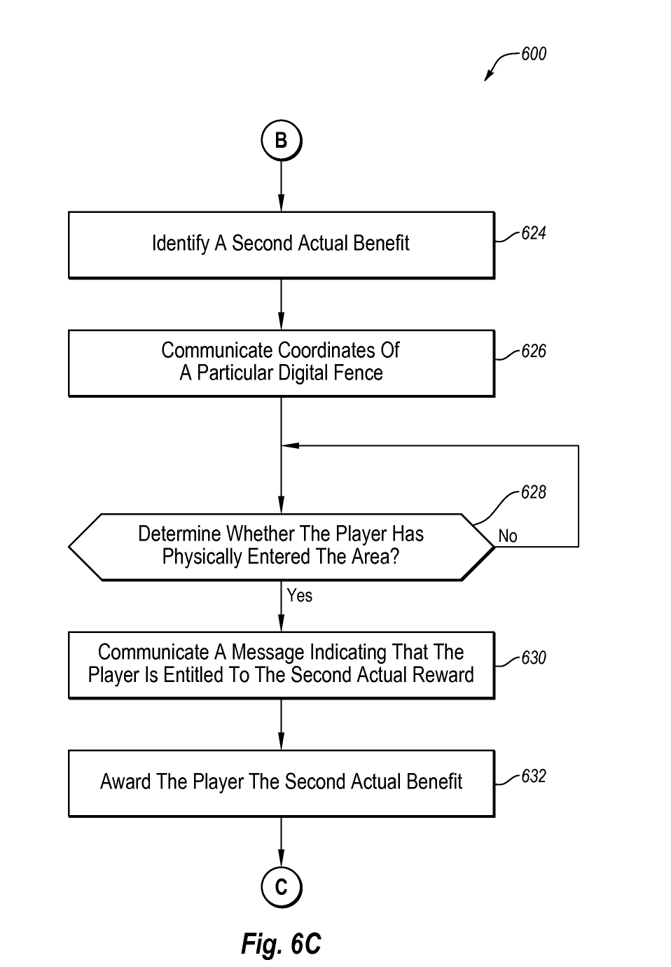

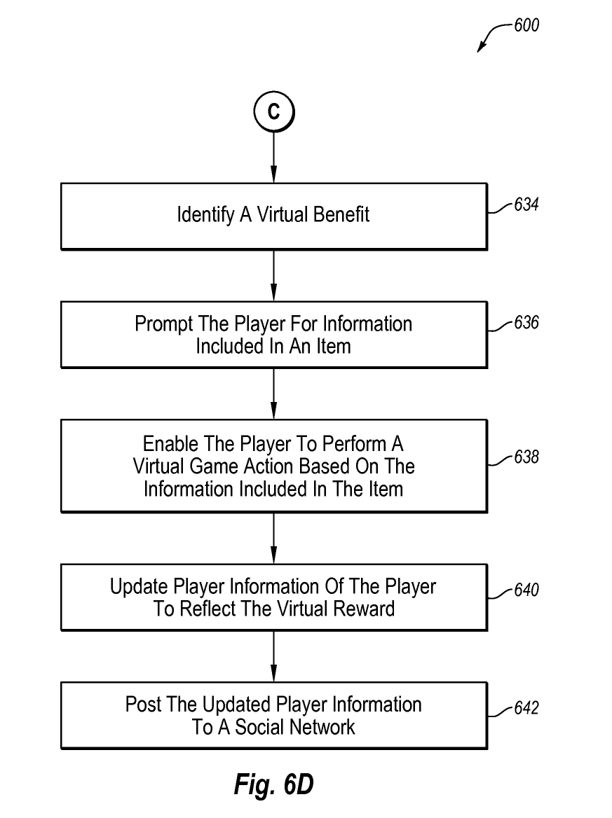

FIGS. 6A-6D are a flow diagram of an example method 600 of awarding an actual benefit in a geocaching environment, arranged in accordance with at least one embodiment described herein. The method 600 may be programmably performed in some embodiments by the computing device 200 described with reference to FIG. 2. Additionally or alternatively, the method 600 may be programmably performed by the geocache server 116 of FIG. 1. The geocache server 116 and/or the computing device 200 may include or may be communicatively coupled to a non-transitory computer-readable medium (e.g., the memory 222 of FIG. 2) having stored thereon or encoded therein programming code or instructions that are executable by a processor to perform or cause performance of the method 600. The geocache server 116 and/or the computing device 200 may include a processor (e.g., the processor 224 of FIG. 2) that is configured to execute computer instructions to cause or control performance of the method 600. Although illustrated as discrete blocks, various blocks may be divided into additional blocks, combined into fewer blocks, or eliminated, depending on the desired implementation.

Referring to FIG. 6A, the method 600 may begin at block 602. At block 602, a portion of player information and game information may be communicated to the advertiser. For example, with reference to FIG. 1, the player information 128 and the game information 142 may be communicated to the advertiser 124 via the network 140.

At block 604, a bid may be received from the advertiser to sponsor the geoseed. For example, with reference to FIG. 1, the geocache server 116 may receive a bid from the advertiser 124 communicated from the third party server 112 to the geocache server 116 via the network 140. Additionally or alternatively, a bid may be received from the advertiser to sponsor a digital fence. At block 606, the bid may be accepted from the advertiser to sponsor the geoseed. For example, with reference to FIGS. 1 and 5, the ad module 132 may accept the bid from the advertiser 124 to sponsor the card geoseed 502B. Additionally or alternatively, the bid may be accepted from the advertiser to sponsor a digital fence (e.g., the digital fence 404).

At block 608, a sponsorship of the geoseed may be associated with the advertiser. For example, with reference to FIGS. 1 and 5, a sponsorship of the card geoseed 502B may be associated with the advertiser 124. Additionally or alternatively, a sponsorship of the digital fence may be associated with the advertiser. At block 610, an indication may be received of the actual benefit provided for locating the geoseed from the advertiser. For example, with reference to FIGS. 1 and 5, an indication may be received at the ad module 132 of the actual benefit provided for locating the card geoseed 502B from the advertiser 124.

Referring to FIG. 6B, at block 612, a player inquiry 612 may be received. For example, with reference to FIG. 1, the geocache module 130 may receive a player inquiry. At block 614, coordinates of a geocache may be communicated. In some embodiments, the coordinates of the geocache may be communicated in response to the player inquiry. For example, with reference to FIGS. 1 and 5, the geocache module 130 may communicate coordinates of the geocache 402.

At block 616, the actual benefit provided for locating the geoseed may be identified. The actual benefit may be associated with the advertiser. In some embodiments, the actual benefit may be identified concurrently with the communication of the coordinates. For example, with reference to FIGS. 1 and 5, the geocache module 130 may identify to the player 102 the actual benefit for locating the card geoseed 502B. The actual benefit may be associated with the advertiser 124.

At block 618, a confirmation signal may be received. The confirmation signal may indicate that a player has located the geocache. The confirmation signal may include verification information specific to the geoseed. For example, with reference to FIGS. 1 and 5; the geocache module 130 may receive a confirmation signal from the player 102 after the player 102 has located the card geoseed 502B. The confirmation signal may include the card number 504B. At block 620, the verification information may be authenticated. For example, with reference to FIGS. 1 and 5, the geocache module 130 may authenticate the card number 504B. At block 622, the player may be awarded the actual benefit.

With reference to FIG. 6C, at block 624, a second actual benefit may be identified. The second actual benefit may be provided for physically entering an area surrounded by a particular digital fence. The digital fence may be configured by an administrator and/or an advertiser. For example, with reference to FIGS. 1 and 4, the geocache module 130 may identify the second actual benefit for entering the area surrounded by the digital fence 404. At block 626, coordinates of the particular digital fence may be communicated. In some embodiments, the coordinates may be communicated to the device associated with the player. For example, with reference to FIGS. 1 and 4, the geocache module 130 may communicate coordinates to the player 102 and/or the device 104 associated with the player 102.

At block 628, it may be determined whether the player has physically entered the area. The determination may be based on locational data received from a device associated with the player. For example, with reference to FIGS. 1 and 4, the geocache module 130 may determine whether the player 102 has physically entered the area surrounded by the digital fence 404. The determination may be based on locational data received from the device 104 associated with the player 102. In response to a determination that the player has not physically entered the area (“No” at block 628), the method 600 may wait until the locational data indicates that the player has physically entered the area.

In response to a determination that the player has physically entered the area (“Yes” at block 628), the method 600 may proceed to block 630. At block 630, a message may be communicated indicating that the player is entitled to the second actual benefit. The message may be communicated to a device associated with the player in response to a determination that the player has physically entered the area. For example, with reference to FIGS. 1 and 4, the geocache module 130 may communicate a message to the device 104 of the player 102 when the player 102 has entered an area surrounded by the digital fence 404. At block 632, the player may be awarded the second actual benefit. For example, with reference to FIG. 1, the player 102 may be awarded with the second actual benefit by the geocache server 116.

With reference to FIG. 6D, at block 634, a virtual benefit may be identified. The virtual benefit may be provided for locating the geoseed. The virtual benefit may be configured for use in a game involving locating the geocache. The game may include virtual game actions performed through communication of digital data via a network and actual game actions performed in a real-world environment. The geocache may have placed therein an item used in the game. At block 636, the player may be prompted for information included in the item. For example, with reference to FIGS. 1 and 3, the geocache module 130 and/or the game module 134 may prompt the player 102 for information on the clue portions 302.

At block 638, the player may be enabled to perform a virtual game action. The virtual game action may be based on the information included in the item. For example, with reference to FIG. 1, the game module 134 may enable the player 102 to perform a virtual game action in a game hosted by the game module 134. At block 640, player information may be updated of the player to reflect the virtual benefit. In some embodiments, the player information may be updated in response to receiving the confirmation signal. For example, with reference to FIG. 1, the game module 134 may update the player information 128. At block 642, the updated player information may be posted to a social network. For example, with reference to FIG. 1, the game module 134 may post the updated player information 128 to the social network hosted by the social media server 114.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments.

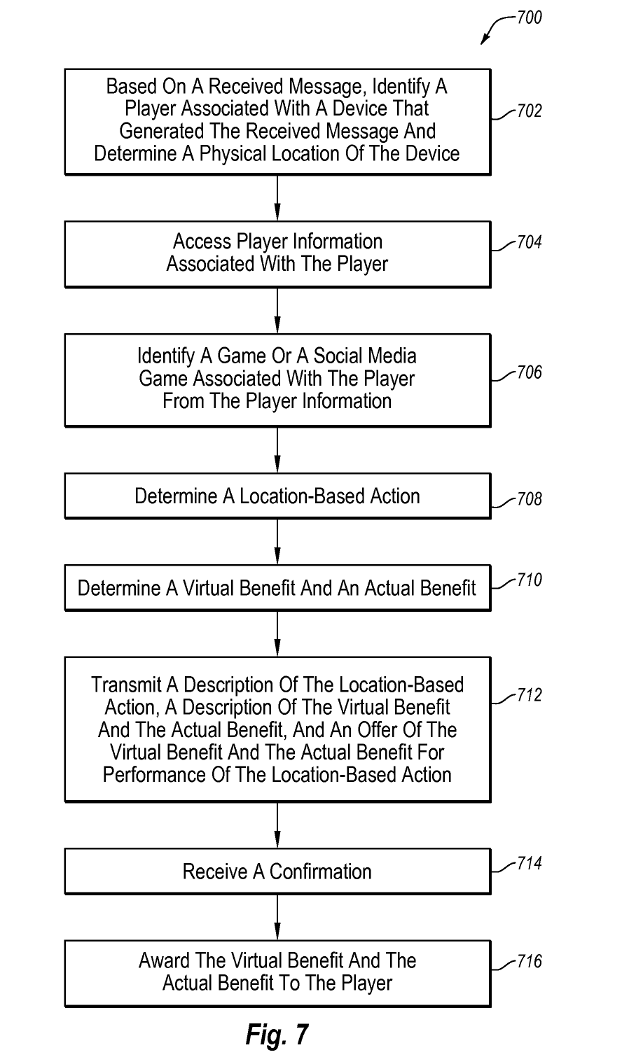

FIG. 7 is a flow diagram of another example method 700 of awarding an actual benefit in a geocaching environment, arranged in accordance with at least one embodiment described herein. The method 700 may be programmably performed in some embodiments by the geocache server 116 or the computing device 200. The geocache server 116 and/or the computing device 200 may include or may be communicatively coupled to a non-transitory computer-readable medium (e.g., the memory 222 of FIGS. 2A and 2B) having stored thereon or encoded therein programming code or instructions that are executable by a processor to perform or cause performance of the method 700. The geocache server 116 and/or the computing device 200 may include a processor (e.g., the processor 224 of FIGS. 2A and 2B) that is configured to execute computer instructions to cause or control performance of the method 700. Although illustrated as discrete blocks, various blocks may be divided into additional blocks, combined into fewer blocks, or eliminated, depending on the desired implementation.

The method 700 may begin at block 702. At bock 702, a player associated with a device may be identified and a physical location of the device may be identified. The player and the device may be identified based on a received message. The device may be the device that generated the received message. In some embodiments, the received message may be automatically generated at the device based on proximity of the device to the physical location. Additionally or alternatively, the received message may include GPS coordinates of a geographical location of the player at the time the received message is generated. The received message may also include an indication that the player has purchased an item at the physical location. At block 704, player information associated with the player may be accessed. At block 706, a game or a social media game associated with the player may be identified from the player information.

At block 708, a location-based action may be determined. The location-based action may be for the player to perform at the physical location. The location-based action may be based on one or more of the attributes of the physical location. The location-based action may include purchasing an item at the physical location, spending a specified amount of legal currency at a location related to the location-based action, locating a pet seed at a location related to the location-based action, spending a specified amount of legal currency at a location related to the location-based action, visiting a location related to the location-based action, or some combination thereof.

The attributes may include types of items available at a location related to the location-based action, demographics of visitors of a location related to the location-based action, a geography of an area surrounding a location related to the location-based action, activities performed at a location related to the location-based action, duration of activities performed at a location related to the location-based action, a brand or a trademark associated with a location related to the location-based action, weather at a location related to the location-based action, or some combination thereof. The location related to the location-based action may include the physical location, an area surrounded by a digital fence that is a basis of the location-based action, a store at the physical location, and the like.

At block 710, a virtual benefit and an actual benefit may be determined. The virtual benefit and the actual benefit may be provided to the player for completion of the location-based action. The virtual benefit and the actual benefit may be based on, at least partially, the location-based action and the game or social media game associated with the player. At block 712, a description of the location-based action, a description of the virtual benefit and the actual benefit, and an offer of the virtual benefit and the actual benefit for performance of the location-based action may be transmitted to the device.

At block 714, a confirmation may be received. The confirmation may indicate that the player performed the location-based action. In some embodiments, the confirmation includes GPS coordinates of the device indicating that the player has performed the location-based action, a numerical code obtained from a location related to the location-based action, a scannable code obtained from a location related to the location-based action, a proof of purchase, or some combination thereof. At block 716, the virtual benefit and the actual benefit may be awarded to the player. In some embodiments, the virtual benefit and the actual benefit may be awarded to the player in response to the confirmation.

In some embodiments, the method 700 may include accessing a game account of a player. From the game account, the game information of the player in the game or the social media game associated with the player may be identified. The game information may include a player character and in-game assets. In these and other embodiments, determining the location-based action may be further based on the game information.

In some embodiments, a social media game is identified as being associated with the player. The virtual benefit includes advancement in the social media game for the player. The confirmation is communicated via a social media server and the awarding the virtual benefit and the actual benefit includes posting a notification of the virtual benefit and the actual benefit to an information feed of the player in a social network.

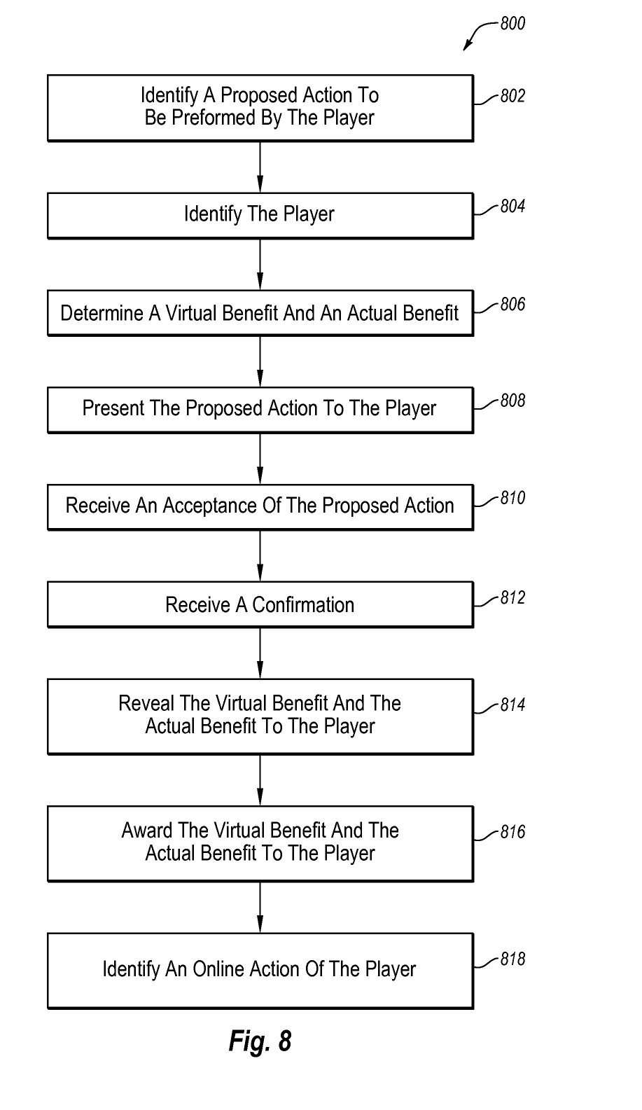

FIG. 8 is a flow diagram of another example method 800 of awarding an actual benefit in a geocaching environment, arranged in accordance with at least one embodiment described herein. The method 800 may be programmably performed in some embodiments by the geocache server 116 or the computing device 200. The geocache server 116 and/or the computing device 200 may include or may be communicatively coupled to a non-transitory computer-readable medium (e.g., the memory 222 of FIGS. 2A and 2B) having stored thereon or encoded therein programming code or instructions that are executable by a processor to perform or cause performance of the method 800. The geocache server 116 and/or the computing device 200 may include a processor (e.g., the processor 224 of FIGS. 2A and 2B) that is configured to execute computer instructions to cause or control performance of the method 800. Although illustrated as discrete blocks, various blocks may be divided into additional blocks, combined into fewer blocks, or eliminated, depending on the desired implementation.

The method 800 may begin at block 802. At block 802, a proposed action to be performed by the player may be identified. For example, the proposed action may be identified during interaction of the player in a virtual environment of a game or a social media game. In some embodiments, a server such as the geocache server 116 may identify the proposed action. At block 804, the player may be identified. For example, a server such as the geocache server 116 may identify the player.

At block 806, a virtual benefit and an actual benefit may be determined. The virtual benefit and the actual benefit may be provided to the player for completion of the proposed action. The virtual benefit and the actual benefit may be determined based on the identified proposed action and player information associated with the player. In some embodiments, the virtual benefit and the actual benefit may be further based on a frequency of play of the game or the social media game, a duration of the play, a category of actual awards selected by the player, a play preference of the player, an amount of time until the player performs the proposed action, or any combination thereof. For example, a server such as the geocache server 116 may determine the virtual benefit and the actual benefit.

At block 808, the proposed action may be presented to the player. At block 810, an acceptance of the proposed action may be received. At block 812, a confirmation may be received. The confirmation may indicate that the player performed the proposed action. At block 814, the virtual benefit and the actual benefit may be revealed. In some embodiments, the virtual benefit and the actual benefit may be revealed to the player after the player performs the proposed action. At block 816, the virtual benefit and the actual benefit may be awarded to the player. The virtual benefit and the actual benefit may be awarded to the player in response to the confirmation.

At block 818, an online action of the player may be identified. In some embodiments, the online action of the player may be identified during interaction of the player in an online environment. The virtual benefit and the actual benefit may be determined based, at least partially, on the online action. The online action may include an online purchase of a product, a submission of a review by the player, a viewing of online media content, a view of an advertisement or a sponsored web link, or some combination thereof.

In some embodiments, the method 800 may include accessing a game account of a player. Additionally, the method 800 may include identifying game information of the player in the game or the social media game associated with the player from the game account. In these and other embodiments, the determining the virtual benefit and the actual benefit may be further based, at least partially, on the game information. The game information may include a player character and in-game assets, for instance.

In some embodiments, the proposed action is identified during interaction of the player in the virtual environment of a social media game. Additionally, the virtual benefit may include advancement in the social media game for the player. The confirmation may be communicated via a social media server. The awarding the virtual benefit and the actual benefit includes posting a notification of the virtual benefit and the actual benefit to an information feed of the player in a social network.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may comprise tangible computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method comprising:
during interaction of a player in a virtual environment of a game or a social media game, identifying a proposed action to be performed by the player;
identifying the player;
determining a virtual benefit and an actual benefit provided to the player for completion of the proposed action based on the identified proposed action and player information associated with the player;
presenting the proposed action to the player;
receiving an acceptance of the proposed action;
receiving a confirmation that the player performed the proposed action; and
in response to the confirmation, awarding the virtual benefit and the actual benefit to the player.

2. The method of claim 1, wherein the determining the virtual benefit and the actual benefit is further based on one or more of or any combination of:
a frequency of play of the game or the social media game;
a duration of the play;
a category of actual awards selected by the player;
a play preference of the player; and
an amount of time until the player performs the proposed action.

3. The method of claim 1, further comprising revealing the virtual benefit and the actual benefit to the player after the player performs the proposed action.

4. The method of claim 1, wherein:
the proposed action is identified during interaction of the player in the virtual environment of a social media game;
the virtual benefit includes advancement in the social media game for the player;
the confirmation is communicated via a social media server; and
the awarding the virtual benefit and the actual benefit includes posting a notification of the virtual benefit and the actual benefit to an information feed of the player in a social network.

5. The method of claim 1, further comprising:
accessing the game account of the player; and
from the game account, identifying game information of the player in the game or the social media game associated with the player,
wherein the determining the virtual benefit and the actual benefit are further based on the game information and the game information includes a player character and in-game assets.

6. The method of claim 1, further comprising during interaction of the player in an online environment, identifying an online action of the player, wherein the determining the virtual benefit and the actual benefit is further based on the online action.

7. The method of claim 6, wherein the online action includes one or more of or any combination of:
an online purchase of a product;
a submission of a review by the player;
a viewing of online media content;
a view of an advertisement or a sponsored web link.

8. A non-transitory computer-readable medium having encoded therein programming code executable by a processor to perform or control performance of operations of claim 1.

9. A method comprising:
based on a received message, identifying a player associated with a device that generated the received message and determining a physical location of the device;
accessing player information associated with the player;
identifying a game or a social media game associated with the player from the player information;
determining a location-based action for the player to perform at the physical location based on one or more of the attributes of the physical location;
further determining a virtual benefit and an actual benefit to be provided to the player for completion of the location-based action, the virtual benefit and the actual benefit being based on the location-based action and the game or social media game associated with the player;
transmitting to the device a description of the location-based action, a description of the virtual benefit and the actual benefit, and an offer of the virtual benefit and the actual benefit for performance of the location-based action;
receiving a confirmation that the player performed the location-based action; and
in response to the confirmation, awarding the virtual benefit and the actual benefit to the player.

10. The method of claim 9, wherein the received message includes global positioning system (GPS) coordinates of the physical location of the player at the time the received message is generated or an indication that the player has purchased an item at the physical location.

11. The method of claim 10, wherein the received message is automatically generated at the device based on a proximity of the device to the physical location.

12. The method of claim 9, wherein the confirmation includes one or more of or a combination of:
GPS coordinates of the device indicating that the player has performed the location-based action;
a numerical code obtained from a location related to the location-based action;
a scannable code obtained from a location related to the location-based action; and
a proof of purchase.

13. The method of claim 9, further comprising:
accessing a game account of the player; and
from the game account, identifying game information of the player in the game or the social media game associated with the player,
wherein the determining the location-based action is further based on the game information.

14. The method of claim 11, wherein:
the game information includes a player character and in-game assets; and
the attributes include types of items available at a location related to the location-based action, demographics of visitors of a location related to the location-based action, a geography of an area surrounding a location related to the location-based action, activities performed at a location related to the location-based action, duration of activities performed at a location related to the location-based action, a brand or a trademark associated with a location related to the location-based action, and weather at a location related to the location-based action.

15. The method of claim 9, wherein the location-based action includes one or more of or a combination of:
purchasing an item at the physical location,
spending a specified amount of legal currency at a location related to the location-based action,
locating a pet seed at a location related to the location-based action,
spending a specified amount of legal currency at a location related to the location-based action, and
visiting a location related to the location-based action.

16. The method of claim 1, wherein:
a social media game is identified as being associated with the player;
the virtual benefit includes advancement in the social media game for the player;
the confirmation is communicated via a social media server; and
the awarding the virtual benefit and the actual benefit includes posting a notification of the virtual benefit and the actual benefit to an information feed of the player in a social network.

17. A non-transitory computer-readable medium having encoded therein programming code executable by a processor to perform or control performance of operations of claim 9.
